(19) United States
(12) Patent Application Publication
(10) Pub. No.: US 2006/0164647 A1
(43) Pub. Date: Jul. 27, 2006

(54) Apparatus for marking a defect

(75) Inventor: Kenro Shibata, Koshigaya-shi (JP)

Correspondence Address: FRISHAUF, HOLTZ, GOODMAN & CHICK, PC, 220 Fifth Avenue, 16TH Floor, NEW YORK, NY, 10001-7708, US

(73) Assignee: NAGASE & CO., LTD., Osaka-shi (JP)

(21) Appl. No.: 11/325,640

(22) Filed: Jan. 4, 2006

(30) Foreign Application Priority Data
Jan. 13, 2005 (JP) 2005-6063
Mar. 25, 2005 (JP) 2005-87894
Apr. 11, 2005 (JP) 2005-113083
Oct. 24, 2005 (JP) 2005-308121
Oct. 24, 2005 (JP) 2005-308128

(51) Int. Cl. G01N 21/84

(52) U.S. Cl. 356/430; 382/141

(57) ABSTRACT

An apparatus for marking a defect detects a defect in a long sheet product transferred in a longitudinal direction by an inspection apparatus and places a mark at the defect at a position downstream of the inspection apparatus. An oil-based marking pen is contained in a container tube having a shutter for closing the tip of the pen. The shutter is opened based on a signal sent from the inspection apparatus, a mark is placed at the defect in the long sheet product by the tip of the pen pushed out of the container tube, the pen is pulled back into the container tube after the marking is completed, and the shutter is closed. The mark can be placed at the portion of the detected defect by an oil-based marking pen without causing a decrease in the marking property due to drying of the tip of the pen.

### BACKGROUND OF THE INVENTION

1. Field of the Invention

The present invention relates to an apparatus for marking a defect. More particularly, the present invention relates to an apparatus for marking a defect which detects a defect in a product having a long sheet form and transferred in the longitudinal direction by an inspection apparatus, and places a mark at the portion of the detected defect by an oil-based marking pen without causing a decrease in the marking property due to drying of the tip of the pen.

The present invention also relates to embodiments in which the apparatus for marking a defect by an oil-based marking pen described above is applied to specific apparatuses for marking a defect developed by the present inventors.

Thus, the present invention relates also to an apparatus for slitting a film, and more particularly to an apparatus for slitting a film which detects a defect present in a film when a material film is slit and wound and places a mark at the portion of defect in each product film obtained by the slitting.

The present invention also relates to an apparatus for marking a defect which detects a defect in a product having a long sheet form and transferred in the longitudinal direction by an inspection apparatus and accurately places a mark at the position of the defect with stability even when many defects are locally concentrated.

The present invention also relates to an apparatus for marking a defect which detects a defect in a product having a long sheet form and transferred in the longitudinal direction, places a mark accurately and clearly at the portion of the detected defect without causing damages to the product having a long sheet form and allows removal or repair of the portion of defect easily in a later step.

2. Description of Related Art

In the process for producing a product having a long sheet form such as films and sheets of synthetic resins, defects are automatically detected by an inspection apparatus in the step of transfer of the product having the sheet form, a mark is placed on the portion of the detected defect at a downstream position in the direction of the transfer, and the portion of defect is removed or repaired using the mark as the index in a later step. In the detection and marking of a defect, the defect is recognized by processing an image obtained by an image capturing means such as a CCD, a marking apparatus is operated by a inspection apparatus at a downstream position in the direction of transfer in accordance with the speed of transfer of the product having a sheet form and the size of the defect, and a mark parallel with the longitudinal direction of the product having a sheet form is placed at the portion of defect. Due to the progress in the image capturing means and the computer, it has become easier to accurately decide the position for placing a mark. However, the marking to the product having a sheet form depends inevitably on a physical means. Therefore, many problems remain to be overcome, and various means for marking have been attempted.

For example, when a section having a prescribed shape is produced by cutting a product having a sheet form, as the method for marking a defect in the product having a sheet form which assures the absence of defects in the section and suppresses a decrease in the yield, a method for marking a defect in a product having a sheet form in which marks are placed at positions in a prescribed range in the vicinity of the defect at both sides in the transverse direction, is proposed, and a method of placing marks at the portion of defect by a felt pen or by a marker of the ink-jet type, is described (Patent Reference 1, page 5). However, when a felt pen is used, the tip of the pen is dried in a short time, and the marking becomes difficult. When an ink of the slow drying type is used for preventing vaporization of the solvent, the ink attached to the product having a sheet form tends to be transferred to facilities for the production and to other portions of the product having a sheet form. To prevent such transfer of the ink, it is necessary that the product having a sheet form be passed through a drier after the mark is placed. When the marker of the ink-jet type is used, clogging of the head tends to take place when an ink of the quick drying type is used, and it is necessary that cleaning of the tip of the head be conducted frequently. When an ink of the slow drying type is used, it is necessary that the product having a sheet form be dried.

As the method for placing a mark without blotting of the ink or disappearance of the mark, a method of forming a physical mark at the portion of defect of a product having a sheet form by a grindstone or the like, is proposed (Patent Reference 2, pages 2 and 5). As the method for clearly showing a defect in a product having a sheet form by placing a mark, a method of placing a physical mark such as a blade mark, a cut mark or a wear mark on the face opposite to the face having the defect using a marking tool made of a material having a great hardness or a blade, is proposed (Patent Reference 3, page 2). However, when the physical mark is formed in the product having a sheet form, the strength of the portion having the physical mark decreases, and accidents such as fracture tend to take place in later steps of the working. When a physical mark is formed in the product having a sheet form, it is inevitable that dusts of cutting are formed. When the dusts are mixed into the product, the quality of the product decreases. For completely removing the formed dusts, a specific apparatus for sucking the dusts is necessary, and the cost of production increases.

The related art for the apparatus for slitting a film used as the apparatus for marking a defect of the present invention will be described in the following. Various films, such as films for optical applications, carrier tapes for mounting electronic parts, films for separators of batteries, films for magnetic recording media, films for condensers prepared by vapor deposition, polarizing films, cassette films for endoscopes, films for photoresists, heat sensitive transfer films, films for packaging and microfilms, are produced by slitting a material film having a greater width into films having a prescribed width while the material film is transferred, and the obtained films are wound as product films of intermediate products or final products.

When a defect is present in a film, the portion of defect is repaired or removed in a later step of the working when the product film is an intermediate product. When the product film is a final product, it is necessary that the product film be used with care so that the portion of the defect is not used. For this purpose, various apparatus for inspection for detecting defects are developed. For example, as the apparatus which can leave a record of the result of the inspection of a film, improve the quality of the inspection, save the space for the apparatus, and be easily handled, an apparatus for inspection of films which is equipped with an inspection table which electrostatically attaches a film used for printing, a one-dimensional image reading head which reads an image of the film by the operation covering the film on the inspection table from one end to the other end, an image processing portion which treats signals produced by the reading head, compares previously recorded image data and newly recorded image data and finds a portion showing a difference between the image data, and a plotter mechanism which, marks the portion of the difference on the new film present on the inspection table, is proposed (Patent Reference 4). Very accurate inspection can be made by using this apparatus. However, since every cut sheet of a final product or a product close to a final product is placed on the inspection table for conducting the inspection, the efficiency inevitably decreases.

As an inexpensive inspection apparatus which can detect a pin hole formed on a film with a great sensitivity while the film is transferred, an inspection apparatus which has a means for detecting a pin hole equipped with two slits extending in the transverse direction of the film and detecting a pin hole based on the change in the amount of the light transmitted through the film irradiated with light via slits and a means for measuring the timing of detection which measures the timing of detection of the pin hole, and in which the distance in the direction of the transfer between a slit placed at a upstream position and a slit placed at a downstream position in the direction of the transfer of the film is set uniquely in the transverse direction, and the position of the pin hole in the transverse direction is decided based on the difference in the times of detection from the two means for detecting a pin hole which are measured by the means for measuring the timing of detection, is proposed (Patent Reference 5). By using this apparatus, a film can be inspected for a defect while the film is transferred. However, the object of the inspection is limited to pin holes transmitting light, and the detected defect cannot be marked immediately.

As the related art for the means for marking used in the apparatus for marking a defect of the present invention, in the process for producing a product having a long sheet form such as films and sheets of synthetic resins, defects are automatically detected by an inspection apparatus in a step where the product having a sheet form is transferred, the portion of defect is marked at a downstream position in the direction of the transfer, and the portion of defect is repaired or removed in a later step using the mark as the index. The detection and the marking of a defect is conducted by recognizing the defect by processing an image obtained by an image capturing means such as CCD, operating a marking apparatus at a downstream position in the direction of transfer by the inspection apparatus in accordance with the speed of transfer of the product having a sheet form and the size of the defect, and placing a mark parallel with the longitudinal direction of the product having a sheet form at the portion of defect. Due to the progress in the image capturing means and the computer, it has become easier to accurately decide the position for placing a mark. However, the placement of the mark in the product having a sheet form depends inevitably on a physical means. Therefore, many problem remain to be overcome, and various means for marking have been attempted.

For example, as the apparatus for marking a defect on a product having a sheet form which can directly mark the position of the defect in the product having a sheet form and efficiently and surely mark the position of the defect without decreasing the yield, an apparatus in which the intensity of light is detected at positions corresponding to positions in the transverse direction of the product having a sheet form, the presence or the absence of a defect is decided by comparing the obtained intensity of light with the reference value by a means for judging on a defect, the information on the position of the defect in the transverse direction of the product having a sheet form is memorized in a means for memorizing the position of a defect when it is decided that a defect is present, the information on the position of the defect in the transverse direction is provided to a means for controlling the position for marking to control the position for the marking, the information of the time of detection when the defect is detected by the means for detection and the speed of transfer of the product having a sheet form detected by the means for detecting the speed of transfer of a sheet are provided to the means for controlling the position for marking so that the time of the marking by the means for marking is controlled, is proposed. As an example of the mechanism for moving a pen of the marking apparatus in the transverse direction, a mechanism in which a table for attaching a pen having an inner screw is fitted with a bar having an outer screw fitting the inner screw, the table is moved in the transverse direction by rotating the bar, and the position of the pen is decided, is shown (Patent Reference 6). However, when many defects are found, a great amount of information must be sent from the means for memorizing the position of defects to the means for marking, and it is practically inevitable that the amount of information sent from the means for detection to the means for marking be restricted. In this case, an unmarked area where no marking can be conducted is formed, and this causes the presence of defects in the final product.

As the apparatus for marking a defect which assures the absence of defects in a portion obtained by cutting out and suppresses a decrease in the yield when a product is produced by cutting out a portion having a prescribed shape from a product having a sheet form, an apparatus for marking a defect which places marks at positions before and after the portions of the detected defect in the longitudinal direction of the product having a sheet form, is used. However, when many defects are locally concentrated in the product having a sheet form, it occasionally occurs that the amount of information sent into the apparatus for image processing exceeds the capacity of the computer and the marking head, and placing marks to individual defects becomes impossible.

The related art for the invention using a solenoid used in the apparatus for placing a mark in the apparatus for marking a defect of the present invention will be described.

For example, when a section having a prescribed shape is produced by cutting a product having a sheet form, as the method for placing a mark at the position of the defect for assuring the absence of defects in the section and suppressing a decrease in the yield, a method of placing a mark using a marker of the ink-jet type or a felt pen is reported. However, when the marker of the ink-jet type is used, clogging of the head tends to take place when an ink of the quick drying type is used, and it is necessary that cleaning of the tip of the head be conducted frequently. When an ink of the slow drying type is used, it is necessary that the product having a sheet form be dried. Reduction in the size of the marker of the ink-jet type is limited, and it is difficult that heads are arranged at a distance as small as 22 mm between each other. Even when this arrangement were possible, this arrangement would causes a great increase in the cost of the apparatus. Although the head of the marker of the ink-jet type can be moved to the portion of the defect, this method cannot deal with defects taking place on the same line. For the marking by a felt pen, the felt pen must be moved from the waiting position to the position of the marking. It is not easy that a felt pen is moved quickly and accurately, and the marks placed at the portion of defect of the product having a sheet form tend to become obscure or inaccurate. When a driving mechanism having a great size is used for quickly moving the felt pen, the distance between adjacent felt pens in the marking head increases, and a portion having great area must be removed from the product having a sheet form even when the defect has a small size.

As the method for marking a defect which overcomes the problem that a mark placed at the position of a defect is lost and the defect is left without being treated in the working of a sheet using a coater or another working machine, a method for marking a defect in which a defect in a product having a sheet form which is continuously transferred is detected and the position of the defect is clearly shown by placing a mark on the face opposite to the face having the defect or the vicinity thereof in the product having a sheet form using a marking tool having a tip having a great hardness or a blade, is proposed, and a method of driving a grinder having a shaft using a solenoid is described in an example (Patent Reference 3, pages 2 to 4). However, it is described in this reference that the speed of working of the solenoid is not sufficiently great in comparison with the speed of the transfer of the sheet.

As the actuator for driving a marking member in an apparatus for marking a defect, motors such as electric motors, air motors and hydraulic motors, solenoids, air cylinders and hydraulic cylinders can be considered. Among these actuators, the motors require conversion of the rotating movement into a linear movement, and the apparatus for the conversion increases the size of the apparatus. Therefore, it is difficult that many marking members are arranged in a marking head with a small distance between the members. As for the hydraulic cylinder, a return piping is necessary, and the hydraulic cylinder is not suitable for operations at a great speed since the viscosity of the fluid is great. As for the air cylinder, it is necessary that the direction of the stream of the air be changed by valves for controlling the direction using air signals or electric signals, and the reduction in the size is difficult. The solenoid can be directly driven by electric signals, and the size can be reduced. However, the solenoid has a problem in that the stroke is short, and the output power is small.

As the related art for another means for marking used for the apparatus for marking a defect of the present invention, for example, when a section having a prescribed shape is produced by cutting a product having a sheet form, a method for marking a defect in which marks are placed at positions in the vicinity in a prescribed range at both sides of the defect in the transverse direction is proposed as the method for marking a defect in a product having a sheet form at the portion of defect for assuring the absence of defects in the section and suppressing a decrease in the yield (Patent Reference 1, page 5). However, when marks are placed at positions in the vicinity in a prescribed range at both sides of the defect in the transverse direction, many marks are placed in the transverse direction of the long sheet when a plurality of defects arranged on a line in the transverse direction of the long sheet or arranged at positions slightly staggered in the longitudinal direction are detected, and it becomes occasionally difficult to find which pair of marks actually contains the defect.

As the method for placing a mark without blotting of the ink or disappearance of the mark, a method of forming a physical mark at the portion of defect of a product having a sheet form by a grindstone or the like, is proposed (Patent Reference 2, pages 2 and 5). As the method for clearly showing a defect in a product having a sheet form by placing a mark, a method of placing a physical mark such as a blade mark, a cut mark or a wear mark on the face opposite to the face having the defect using a marking tool made of a material having a great hardness or a blade, is proposed (Patent Reference 3, line 2). However, when the physical mark is formed in the product having a sheet form, the strength of the portion having the physical mark decreases, and accidents such as fracture tend to take place in later steps of the working. When a physical mark is formed in the product having a sheet form, it is inevitable that dusts of cutting are formed. When the dusts are mixed into the product, the quality of the product decreases. For completely removing the formed dusts, a specific apparatus for sucking the dusts is necessary, and the cost of production increases.

[Patent Reference 1] Japanese Patent Application Laid-Open No. 2001-305070

[Patent Reference 2] Japanese Patent Application Laid-Open No. 2002-303580

[Patent Reference 3] Japanese Patent Application Laid-Open No. 2002-338111

[Patent Reference 4] Japanese Patent Application Laid-Open No. Heisei 10(1998)-228095

[Patent Reference 5] Japanese Patent Application Laid-Open No. 2000-146861

[Patent Reference 6] Japanese Patent Application Laid-Open No. Heisei 9(1997)-304295

### BRIEF SUMMARY OF THE INVENTION

The present invention has an object of providing an apparatus for marking a defect which can detect a defect in a product having a long sheet form and transferred in the longitudinal direction by an inspection apparatus and can place a mark to the portion of the detected defect by an oil-based marking pen without causing a decrease in the marking property due to drying of the tip of the pen.

The present invention has another object of providing an apparatus for slitting a film which detects a defect present in a film when a material film is slit and wound and places a mark at the position of the defect in each product film obtained by the slitting.

The present invention has another object of providing an apparatus for marking a defect which can detect a defect of a product having a long sheet form and transferred in the longitudinal direction by an inspection apparatus, can accurately place a mark at the position of the defect with stability even when many defects are locally concentrated without causing damages to the portion of defect in the product having a long sheet form and allows removal or repair of the portion of defect easily in a later step.

As the result of intensive studies by the present inventors to achieve the above objects, it was found that the drying of the tip of an oil-based marking pen could be prevented and marks could be efficiently placed on the portion of defect of a product having a sheet form using an ink of the quick drying type when a mark was placed on the portion of defect in the product having a sheet form by an oil-based marking pen equipped with a shutter for closing the tip of the pen, and opening the shutter, pushing out the pen for the marking, pulling back the pen and closing the shutter were conducted in this order based on the signal sent from a inspection apparatus. The present invention has been completed based on this knowledge.

It was also found that, in the apparatus for slitting a film which transfers a broad material film, slits the material film to form product films and winds the formed product films, slitting the material sheet, detecting a defect and marking the portion of defect could be conducted efficiently in a single step when a means for marking was disposed at a position corresponding to the product film, a defect on the transferred material film was detected by an inspection apparatus, and marks were placed on the product film having the defect. The present invention has been completed based on this knowledge.

It was also found that, even when many defects were locally concentrated, marks could be placed accurately with stability at the position of the defect when a product having a long sheet form and transferred to the longitudinal direction was divided into rectangles having a length of an edge in the transverse direction which was the same as the distance between the marking members and a length of an edge in the longitudinal direction having a prescribed value, and, when a defect was detected in a rectangular portion, a mark of a single line having the same length as a length of an edge of the rectangle in the longitudinal direction was placed in the rectangle in the longitudinal direction. The present invention has been completed based on this knowledge.

As the result of intensive studies by the present inventor to achieve the above object, it was found that a marking member for placing a mark in a product having a sheet form could be moved quickly and accurately by using a small solenoid when the marking member was driven by the solenoid, a high voltage was applied to the solenoid only for a short time after the start of the application of the voltage, and the applied voltage is quickly decreased to the regular voltage. The present invention has been completed based on this knowledge.

It was found by the present inventors that, in an apparatus which detects defects in a product having a long sheet form and transferred in a longitudinal direction by an inspection apparatus and places a mark at the portion of the detected defect at a position downstream of the inspection apparatus in a direction of transfer, the length of the mark could be decreased and the placement and the recognition of the mark were facilitated by placing a mark at an upstream position and another mark at a position downstream of the detected defect, and the recognition of the portion of defect could be remarkably facilitated by conducting the marking at the upstream position and at the downstream position using different colors since visual observation of the space between the mark at the upstream position and the mark at the downstream position was sufficient.

The present invention provides:
(1) An apparatus for marking a defect which detects the defect in a product having a long sheet form and transferred in a longitudinal direction by an inspection apparatus and places a mark at the portion of the detected defect at a position downstream of the inspection apparatus in a direction of transfer, wherein an oil-based marking pen is contained in a container tube for an oil-based marking pen having a shutter for closing a tip of the pen, the shutter of the container tube for an oil-based marking pen is opened based on a signal sent from the inspection apparatus, the oil-based marking pen is pushed out of the container tube, a mark is placed at a portion of defect in the product having a long sheet form by the tip of the oil-based marking pen, the oil-based marking pen is pulled back into the container tube after the marking is completed, and the shutter is closed;
(2) The apparatus for marking a defect described in (1), wherein the shutter is opened and closed by working of an air cylinder, and the oil-based marking pen is pushed out and pulled back by working of a solenoid;
(3) The apparatus for marking a defect described in (1), wherein opening and closing the shutter and pushing out and pulling back the oil-based marking pen are conducted by using separate solenoids;
(4) The apparatus for marking a defect described in (1), wherein a solvent of an ink for the oil-based marking pen comprises 80% by weight or more of an aliphatic compound having no halogen atom and having a vapor pressure of 0.5 to 10 kPa at 20° C.;
(5) The apparatus for marking a defect described in (1), wherein the inspection apparatus is a line sensor;
(6) The apparatus for marking a defect described in (1), wherein many oil-based marking pens are arranged at a same distance between each other in a transverse direction of the product having a long sheet form and, when a defect is detected by the inspection apparatus, an oil-based marking pen closest to the defect in the transverse direction moves and places a mark;
(7) The apparatus for marking a defect described in (1), which is used as an apparatus for slitting a film which transfers a material film, slits the material film by (n−1) slitting blades to form n product films and winds formed n product films, wherein n means for marking are disposed at positions corresponding to positions of the n product films, a defect on the transferred material film is detected by the inspection apparatus, and a mark is placed on a product film having the defect;
(8) The apparatus for marking a defect described in (1), which is used as an apparatus for slitting a film which transfers a material film, slits the material film by (n−1) slitting blades to form n product films and winds formed n product films, wherein at least n+1 means for marking are disposed at positions corresponding to positions of the n product films, a defect on the transferred material film is detected by the inspection apparatus, and a mark is placed on a product film having the defect at a position closest to the defect;
(9) The apparatus for marking a defect described in (1), which detects a defect in a product having a long sheet form and transferred in a longitudinal direction by an inspection apparatus and places a mark at the portion of the detected defect at a position downstream of the inspection apparatus in a direction of transfer, wherein a marking head having a plurality of marking members arranged in a transverse direction of the product having a long sheet form is disposed, the product having a sheet form is divided into rectangles having a length of an edge in the transverse direction which is a same as a distance between adjacent marking members and a length of an edge in the longitudinal direction having a prescribed value, and, when a defect is detected in a rectangle, a mark of a single line having a same length as the length of the edge of the rectangle in the longitudinal direction is placed in the rectangle in the longitudinal direction;
(10) The apparatus for marking a defect described in (9), wherein a length of the edge of the rectangle in the longitudinal direction is 0.1 to 10 times as long as a length of the edge of the rectangle in the transverse direction in the product having a sheet form;
(11) The apparatus for marking a defect described in (9), wherein a marking member is placed at a center of an edge of each rectangle in the transverse direction;
(12) The apparatus for marking a defect described in (1), which detects a defect in a product having a long sheet form and transferred in a longitudinal direction by an inspection apparatus and places a mark at the portion of the detected defect at a position downstream of the inspection apparatus in a direction of transfer, wherein a marking member is pushed out and pulled back by working of a solenoid, and a circuit by which a voltage applied to the solenoid and a time of application of the voltage can be adjusted in multiple stages is disposed;
(13) The apparatus for marking a defect described in (12), wherein the solenoid is a solenoid of a push type, and a mechanism by which a voltage 1.3 to 10 times as high as a regular voltage is applied to the solenoid in a period of 4 to 50 ms after application of the voltage to the solenoid is started and the voltage is lowered to the regular voltage after the period, is disposed;
(14) The apparatus for marking a defect described in (1), wherein the apparatus which detects a defect in a product having a long sheet form and transferred in a longitudinal direction by an inspection apparatus and places a mark at the portion of the detected defect at a position downstream of the inspection apparatus in a direction of transfer is used as an apparatus for marking a defect which places a mark at an upstream position and another mark at a downstream position of the detected defect, the defect being placed between the marks; and
(15) The apparatus for marking a defect described in (14), wherein markers having two different colors each in a plurality of numbers are arranged alternately in a transverse direction of the product having a sheet form, and, when a defect is detected by the inspection apparatus, a marker closest to the defect among markers having one color places a mark at a position downstream of the defect and a marker closest to the defect among markers having an other color places a mark at a position upstream of the defect.

### THE EFFECT OF THE INVENTION

By using the apparatus for marking a defect of the present invention, a mark can be efficiently placed on the portion of defect using an ink of the quick drying type in a short production line having no drying step since the tip of the oil-based marking pen for placing a mark on the portion of defect in a product having a sheet form is not dried. When the portion of defect in the vicinity of the mark can be recognized by visual observation, the ink can be wiped out with a solvent, and the portion of defect alone can be removed or repaired. Therefore, the product having a sheet form can be effectively utilized as the raw material for the final product.

By using the apparatus for slitting a film as an application of the apparatus for marking a defect of the present invention, slitting the material film, detecting a defect on the film and marking the portion of defect in the product film formed by the slitting can be conducted efficiently in a single step. Since the mark on the portion of defect is clear, the mark can be easily recognized by visual observation or by image processing. The portion of defect can be removed or repaired in a later step of the working in the case of an intermediate product, and the use of the portion of defect can be avoided in the case of the product film as the final product.

When the apparatus for marking a defect of the present invention is used, since a product having a long sheet form is separated into many rectangles and the presence or the absence of a defect in a rectangle is decided with respect to each rectangle independently of the number of the defect, the mark can be placed accurately with stability at the portion of defect even when many defects are locally concentrated or a great defect extending into many rectangles is present.

When the apparatus for marking a defect of the present invention is used, since a high voltage is applied to a solenoid for pushing out the marking member only for a short time after the start of application of the voltage, the marking member is quickly pushed out by a strong force after the start of the transfer, and the mark is placed accurately and clearly on the portion of defect of a product having a sheet form. Since the applied voltage is decreased after the tip of the marking member reaches the surface of the product having a sheet form, there is no possibility that the solenoid is overheated even when a portion of defect long in the longitudinal direction is present in the product having a sheet form and the marking member is continuously pushed out. Since the marking member is quickly pushed out by a strong force after the start of the transfer, a strong spring can be used as the recovery spring. When the application of the voltage is stopped, the marking member leaves the surface of the product having a sheet form quickly, and the end point of the mark is accurate and clear. When the apparatus of the present invention is used, the distance between adjacent marking members can be decreased by using a solenoid having a small size to which the voltage can be applied instantaneously, in place of using a mechanism for overcoming the force of a strong spring and pushing out the marking member by using a great and powerful solenoid. The area to be covered by a single marking member in the product having a sheet form can be decreased, and the area for the removal in the vicinity of the portion of the detected defect can be decreased.

When the apparatus for marking a defect of the present invention is used, since the marks are placed both at an upstream position and at a position downstream of the detected defect in the product having a long sheet form, defects having a shape long or short in the longitudinal direction of the product having a long sheet form can be treated with short marks. In particular, by using different colors for the marking at an upstream position and for the marking at a downstream position of the detected defect, the defect in the product having a long sheet form can be easily and accurately recognized.

### BRIEF DESCRIPTION OF THE SEVERAL VIEWS OF THE DRAWINGS

FIG. 1 shows a diagram exhibiting an embodiment of the apparatus for marking a defect of the present invention.

FIG. 2 shows a diagram exhibiting another embodiment of the apparatus for marking a defect of the present invention.

FIG. 3 shows a side view and a plan view exhibiting the arrangement of container tubes of an oil-based marking pen.

FIG. 4 shows a diagram exhibiting a mechanism for marking a defect in the apparatus of the present invention.

FIG. 5 shows a diagram exhibiting an embodiment of the method of marking a defect in the apparatus of the present invention.

FIG. 6 shows a diagram exhibiting another embodiment of the method of marking a defect in the apparatus of the present invention.

FIG. 7 shows a schematic side view of an embodiment of an apparatus for slitting a film applied to the apparatus for marking a defect of the present invention.

FIG. 8 shows a side view and a plan view of an embodiment of a marking apparatus used in the apparatus of the present invention.

FIG. 9 shows a schematic plan view of the embodiment of an apparatus for slitting a film shown in FIG. 7.

FIG. 10 shows a schematic side view of another embodiment of the apparatus for slitting a film of the present invention.

FIG. 11 shows a schematic plan view of the embodiment of the apparatus for slitting a film shown in FIG. 10.

FIG. 12 shows a schematic plan view of another embodiment of the apparatus for slitting a film of the present invention.

FIG. 13 shows a schematic plan view of another embodiment of the apparatus for slitting a film of the present invention.

FIG. 14 shows a diagram exhibiting an embodiment of an improved apparatus of the apparatus for marking a defect of the present invention.

FIG. 15 shows a side view and a plan view exhibiting the arrangement of marking members in another embodiment of the apparatus for marking a defect of the present invention.

FIG. 16 shows a diagram exhibiting the method of marking using the apparatus for marking a defect of the present invention.

FIG. 17 shows a diagram exhibiting an example showing the relation between a defect and a mark.

FIG. 18 shows a diagram exhibiting another example showing the relation between a defect and a mark.

FIG. 19 shows a diagram exhibiting another example showing the relation between a defect and a mark.

FIG. 20 shows a diagram exhibiting another example showing the relation between a defect and a mark.

FIG. 21 shows a diagram exhibiting another example showing the relation between a defect and a mark.

FIG. 22 shows a diagram exhibiting an embodiment of a solenoid mechanism in the apparatus for marking a defect of the present invention.

FIG. 23 shows a side view and a plan view exhibiting the arrangement in another embodiment of a solenoid mechanism in the apparatus for marking a defect of the present invention.

FIG. 24 shows a diagram exhibiting an embodiment of a solenoid mechanism in the apparatus for marking a defect of the present invention.

FIG. 25 shows a diagram exhibiting an embodiment of a method of applying a voltage to a solenoid mechanism in the apparatus for marking a defect of the present invention.

FIG. 26 shows a side view of an embodiment of the apparatus for marking a defect of the present invention.

FIG. 27 shows a front view and a plan view exhibiting the arrangement of markers.

FIG. 28 shows a diagram exhibiting an embodiment of a mechanism for marking a defect in the apparatus of the present invention.

FIG. 29 shows a diagram exhibiting another embodiment of a mechanism for marking a defect in the apparatus of the present invention.

The numbers and characters in the figures have the meanings as listed in the following:
1 A product having a sheet form
2 A CCD camera
3 An inspection apparatus
4 A driving apparatus
5 A container tube for an oil-based marking pen
6 A solenoid
7 A shutter
8 An air cylinder
9 A supporting roll
10 A shutter
11 A solenoid
12 A product having a sheet form
13 A defect
14 A mark
15 A rectangle
16 An oil-based marking pen
17 A tip of a pen
18 A wire
19 An oil-based marking pen
20 A tip of a pen
21 A spring coil
B1 A material roll
B2 A material film
B3 A slitting blade
B4 A product film
B5 A product roll
B6 A CCD camera
B7 An inspection apparatus
B8 A marking apparatus
B9 A solenoid
B10 An oil-based marking pen
B11 A supporting roll
B12 A defect
B13 A mark
B14 A defect
B15 A mark
B16 A defect
B17 A mark
C1 A product having a sheet form
C2 A CCD camera
C3 An inspection apparatus
C4 A computer
C5 A solenoid
C6 A marking member
C7 A supporting roll
C8 A marking head
C9 Edge portions at both sides
C10 A defect
C11 A mark
C12 A rectangle
D1 A product having a sheet form
D2 A CCD camera
D3 An inspection apparatus
D4 A driving apparatus
D5 A solenoid
D6 An oil-based marking pen
D7 A supporting roll
D8 An air cylinder
D9 A shutter
D10 A defect
D11 A container tube for marking
D12 A tip of a pen
E1 A product having a sheet form
E2 A CCD camera
E3 A solenoid
E4 A driving apparatus
E5 A solenoid
E6 A marker
E7 A supporting roll
E8 A product having a sheet form
E9 A defect
E10 A mark at a position downstream of a defect
E11 A mark at a position upstream of a defect
E12 A rectangle
E13 A defect
E14 A mark at a position downstream of a defect
E15 A mark at a position upstream of a defect
E16 A rectangle

### DETAILED DESCRIPTION OF THE INVENTION

As the basic structure of the apparatus for marking a defect of the present invention, the apparatus for marking a defect detects the defect in a product having a long sheet form and transferred in the longitudinal direction by an inspection apparatus and places a mark at the portion of the detected defect at a position downstream of the inspection apparatus in the direction of transfer, wherein an oil-based marking pen is contained in a container tube for an oil-based marking pen having a shutter for closing the tip of the pen, the shutter of the container tube for an oil-based marking pen is opened based on a signal sent from the inspection apparatus, the oil-based marking pen is pushed out of the container tube, a mark is placed at a portion of defect in the product having a long sheet form by the tip of the oil-based marking pen, the oil-based marking pen is pulled back into the container tube after the marking is completed, and the shutter is closed.

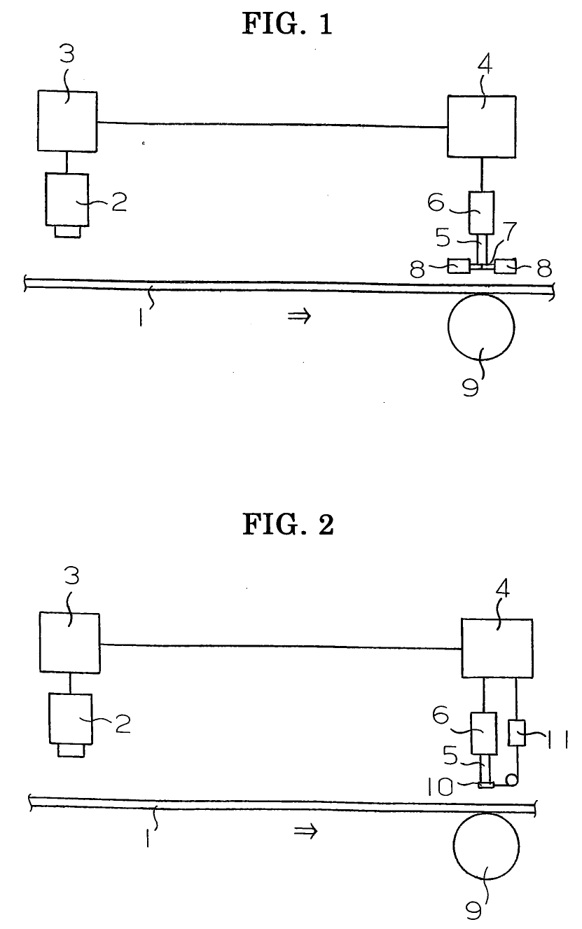

In the apparatus of the present invention, opening and closing the shutter can be conducted by the working of an air cylinder, and pushing out and pulling back the oil-based marking pen can be conducted by the working of a solenoid. FIG. 1 shows a diagram exhibiting an embodiment of the apparatus for marking a defect of the present invention. A product having a sheet form 1 is transferred in the direction shown by an arrow. An image of the product having a sheet form is taken by a CCD camera 2, and the obtained image is processed by an inspection apparatus 3. When a defect is detected in the product having a sheet form, a signal is sent from the inspection apparatus 3 to a driving apparatus 4. In the driving apparatus, a solenoid 6 for pushing out and pulling back an oil-based marking pen contained in a container tube of an oil-based marking pen 5 and cylinders 8 for opening and closing a shutter 7 of the container tube for an oil-based marking pen are disposed. When the signal is sent from the inspection apparatus to the driving apparatus, the air cylinders 8 work, and the shutter 7 is opened. Then, the solenoid 6 works, and the oil-based marking pen contained in the container tube for an oil-based marking pen 5 is pushed out. A mark is placed at a designated position in the product having a sheet form which is transferred on a supporting roll 9. Then, the oil-based marking pen is pulled back into the container tube for an oil-based marking pen, and the shutter 7 is closed by the working of the air cylinders 8. Since the time of working of the solenoid can be made 20 ms or shorter, the oil-based marking pen can be pushed out and pulled back quickly, and the defect in the product having a sheet form can be accurately marked. Since the working time of the air cylinder is longer than the working time of the solenoid, the shutter is kept open until a series of actions for marking the defects is completed and closed after the series of actions for marking the defects is completed when defects are successively detected in the product having a sheet form. During the period when no defects are detected, the oil-based marking pen is contained in the container tube to prevent drying of the tip of the pen, and an ink of the quickly drying type can be used.

In the apparatus of the present invention, opening and closing the shutter and pushing out and pulling back the oil-based marking pen can be made by using separate solenoids. FIG. 2 shows a diagram exhibiting another embodiment of the apparatus for marking a defect of the present invention. A product having a sheet form 1 is transferred in the direction shown by an arrow. An image of the product having a sheet form is taken by a CCD camera 2, and the obtained image is processed by an inspection apparatus 3. When a defect is detected in the product having a sheet form, a signal is sent from the inspection apparatus 3 to a driving apparatus 4. In the driving apparatus, a solenoid 6 for pushing out and pulling back an oil-based marking pen contained in a container tube of an oil-based marking pen 5 and a solenoid 11 for opening and closing a shutter 11 of the container tube for an oil-based marking pen are disposed. When the signal of detection of a defect is sent from the inspection apparatus to the driving apparatus, the solenoid 11 works, and the shutter 10 is opened. Then, the solenoid 6 works, and the oil-based marking pen contained in the container tube for an oil-based marking pen 5 is pushed out. A mark is placed at a designated position in the product having a sheet form which is transferred on a supporting roll 9. Then, the oil-based marking pen is pulled back into the container tube for an oil-based marking pen, and the shutter 10 is closed by the working of the air cylinder 11. Since the time of working of the solenoid can be made 20 ms or shorter, the period of time when the shutter of the container tube for the oil-based marking pen is open can be decreased to prevent drying of the tip of the pen, and an ink of the quick drying type can be used by opening and closing the shutter and pushing out and pulling back the oil-based marking pen using separate solenoids.

In the apparatus of the present invention, the direction of the movement of the oil-based marking pen is not particularly limited. For example, the oil-based marking pen may be lowered from an upper position and pulled back by elevating to the upper position after a mark is placed. The oil-based marking pen may be horizontally moved and pulled back into the container tube in the horizontal direction after a mark is placed. The oil-based marking pen may also be elevated from a lower position and pulled back by lowering to the lower position after a mark is placed. The direction of the movement of the oil-based marking pen may be set at any angle other than the vertical direction and the horizontal direction. When pushing out and pulling back the oil-based marking pen are conducted by the working of a solenoid alone, it is preferable that the direction of the movement of the oil-based marking pen is the horizontal direction since the force of pulling back the oil-based marking pen is given by a spring.

In the apparatus of the present invention, the position at which a mark is placed by the oil-based marking pen in the product having a sheet form is not particularly limited. For example, a mark may be placed at a position on the line of contact between the supporting roll transferring the product having a sheet form and the product having a sheet form. Alternatively, a mark may be placed at a position separated from the line of contact between the supporting roll and the product having a sheet form to the upstream side or to the downstream side. When the mark is placed on the line of contact between the supporting roll and the product having a sheet form, wear of the tip of the oil-based marking pen tends to take place faster. When the mark is place at a position greatly separated from the line of contact between the supporting roll and the product having a sheet form, the stable marking becomes difficult. It is preferable that the position of placing a mark is separated by 1 to 10 mm and more preferably by 3 to 8 mm from the line of contact between the supporting roll and the product having a sheet form.

In the apparatus of the present invention, it is preferable that the solvent in the ink for the oil-based marking pen comprises 80% by weight or more of an aliphatic compound having no halogen atoms and having a vapor pressure of 0.5 to 10 kPa at 20° C. It is more preferable that the solvent in the ink for the oil-based marking pen comprises an aliphatic compound having no halogen atoms and having a vapor pressure of 3 to 9 kPa at 20° C. alone. Aliphatic compounds having no halogen atoms are inactive for most plastics, and the marking can be conducted without causing damages to the product having a sheet form. Since there is the possibility that damages take place in the product having a sheet form when the marking is conducted using an aromatic compound or an aliphatic compound having a halogen atom as the solvent, it is preferable that the solvent comprises 80% or more of an aliphatic compound having no halogen atoms. When the vapor pressure of the solvent at 20° C. is smaller than 0.5 kPa, the drying of the ink is slow, and there is the possibility that the ink is transferred to the apparatuses for the production or to other portions of the product having a sheet form. When the vapor pressure of the solvent at 20° C. exceeds 10 kPa, there is the possibility that the tip of the pen is dried even when the container tube for an oil-based marking pen is equipped with a shutter.

Examples of the aliphatic compound having no halogen atoms and having a vapor pressure of 0.5 to 10 kPa at 20° C. include hydrocarbons such as heptane (4.7), octane (1.5), nonane (0.67) and methylcyclohexane (4.9); alcohols such as ethanol (6.0), propanol (1.9), isopropyl alcohol (4.3), butyl alcohol (0.73), isobutyl alcohol (1.2), sec-butyl alcohol (1.7) and t-butyl alcohol (4.1); glycol ethers such as ethylene glycol monomethyl ether (1.1), ethylene glycol monoisopropyl ether (0.80), propylene glycol monomethyl ether (1.0) and ethylene glycol diethyl ether (1.3); ketones such as methyl ethyl ketone (9.3), methyl propyl ketone (1.6), methyl butyl ketone (1.6), methyl isobutyl ketone (2.1) and dipropyl ketone (0.69); and esters such as butyl formate (2.9), isobutyl formate (4.4), propyl acetate (3.3), isopropyl acetate (6.4), butyl acetate (1.1), isobutyl acetate (1.7), ethyl propionate (3.7) and butyl propionate (6.0). Among these solvents, alcohols and glycol ethers are preferable. The number in the parenthesis following the name of a compound shows the vapor pressure at 20° C. by the unit of kPa.

In the apparatus of the present invention, a mixed solvent may be used as the solvent of the ink for the oil-based marking pen. The vapor pressure of the solvent can be increased and the property of quick drying can be provided to the ink by using a solvent having a high vapor pressure at 20° C. as a component of the mixed solvent. Examples of the solvent having a high vapor pressure at 20° C. include methanol (12.8) and acetone (24.5). The vapor pressure of a mixed solvent can be obtained from the relation of the gas-liquid equilibrium at a constant temperature and a constant pressure.

In the apparatus of the present invention, a fatty acid ester of pentaerythritol can be added to the ink for the oil-based marking pen. By adding a fatty acid ester of pentaerythritol to the ink for the oil-based marking pen, drying of the tip of the pen can be prevented, and a stable marking can be achieved without forming a blurred mark.

As for the oil-based marking pen used in the apparatus of the present invention, it is preferable that no portion of lines drawn by the pen remains on a writing paper in the following test. In the test, spirals are drawn on a glass plate by a hand successively 5 times, a writing paper having a whiteness of 75% or greater is placed on top of the glass having the writing after 20 seconds, the writing paper is pressed under a weight having a diameter of 50 mm and a weight of 500 g, the writing paper is left standing for 1 minute, and then the writing paper is separated from the glass. It is more preferable that no portion of lines drawn by the pen remains on the writing paper when the writing paper is placed after 10 seconds and more preferably after 4 seconds.

The material of the tip of the oil-based marking pen used in the apparatus of the present invention is not particularly limited, and any of tips of a pen made of fibers or plastics can be used. The size of the tip of the oil-based marking pen is not particularly limited. It is preferable that the width of a recorded line is 0.3 to 2.5 mm and more preferably 1 to 2 mm. When the width of a recorded line is smaller than 0.3 mm, there is the possibility that the formed mark is obscure. When the width of the recorded line exceeds 2.5 mm, there is the possibility that the distance of the marking decreases. In the apparatus of the present invention, the color of the oil-based marking pen is not particularly limited. A color easier for recognition by visual observation can be suitably selected in accordance with the color of the product having a sheet form to be used for the inspection.

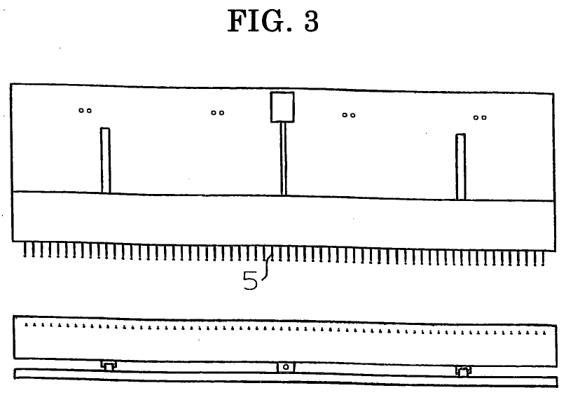

In the apparatus of the present invention, it is preferable that many oil-based marking pens are arranged in the transverse direction of the product having a sheet form at the same distance between each other and, when a defect is detected by the inspection apparatus, an oil-based marking pen closest to the defect is moved to place a mark. FIG. 3 shows a side view and a plan view exhibiting the arrangement of container tubes of an oil-based marking pen. In the present embodiment, many shutters driven by air cylinders or solenoids and many container tubers 5 for an oil-based marking pen containing the oil-based marking pen and driven by solenoids are arranged over the entire width of the product having a sheet form at the same distance between each other. When a defect is detected by the inspection apparatus, the shutter of a container tube for an oil-based marking pen closest to the defect in the transverse direction of the product having a sheet form is opened by the air cylinder or the solenoid for opening and closing the shutter. The oil-based marking pen closest to the defect in the transverse direction of the product having a sheet form is pushed out by the solenoid for pushing out and pulling back the oil-based marking pen, and a mark is placed. It is preferable that the calculation is made by the inspection apparatus so that the length of the mark has a value set in advance. When the length of the defect is great, a plurality of marks may be placed intermittently.

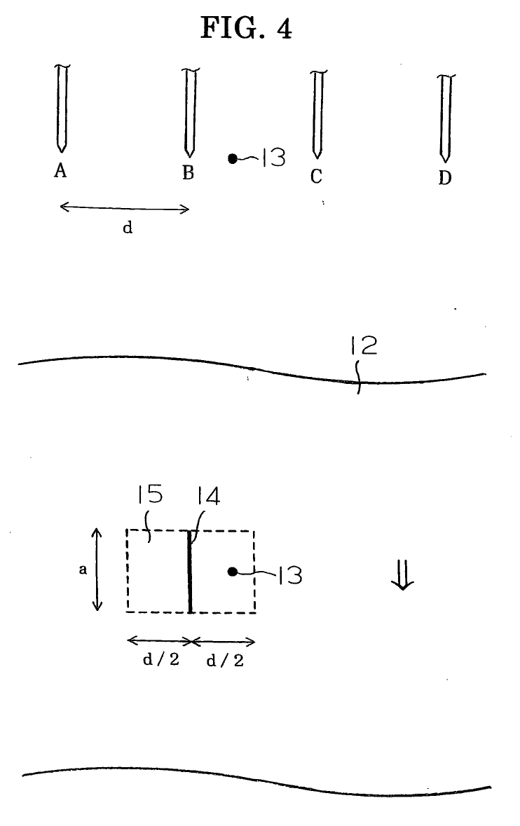

In the apparatus of the present invention, when the defect can be recognized by visual observation using the mark placed on the portion of defect as the index, the portion of defect can be removed or repaired in a later step and, where necessary, the mark can be wiped out with a solvent or the like. When the mark is wiped out, the portion which had the mark can be used as the material for a final product. FIG. 4 shows a diagram exhibiting a mechanism for marking a defect in the apparatus of the present invention. In the present mechanism, many tips of oil-based marking pens A, B, C, D . . . contained in container tubes for an oil-based marking pen are arranged at the same distance d (mm) between each other. When a defect 13 is detected in a product having a long sheet form 12 by the inspection apparatus, an oil-based marking pen closest to the defect in the transverse direction is pushed out at a position downstream of the inspection apparatus in the direction of the transfer, and a mark 14 is placed in the product having a long sheet form by the tip of a pen B. Since the oil-based marking pen closest to the defect in the transverse direction is pushed out, the distance between the mark and the defect is d/2 (mm) or smaller. When the defect cannot be recognized by visual observation, a rectangular portion 15 formed with longitudinal lines having a length which is the length of the mark a (mm) and placed at a position each separated from the mark by d/2 (mm) and transverse lines having a length corresponding to the width is removed. Since it is sure that the defect is present at the inside of the rectangle, the portion of defect can be surely removed by placing one mark alone and removing the portion having the mark at the center and a width which is the same as the distance between the adjacent oil-based marking pens when the apparatus of the present invention is used.

In the apparatus of the present invention, it is preferable that the distance between oil-based marking pens, many of which are arranged in the transverse direction of the product having a sheet form, is 30 mm or smaller and more preferably 15 mm or smaller. By decreasing the distance between the oil-based marking pens, the removed portion of the product having a sheet form can be made smaller when the portion of defect cannot be recognized by visual observation. Since the oil-based marking pen requires less attached facilities than a marking apparatus of the ink-jet type does, the distance between adjacent oil-based marking pens can be decreased to a value close to the thickness of the container tube of the oil-based marking pen.

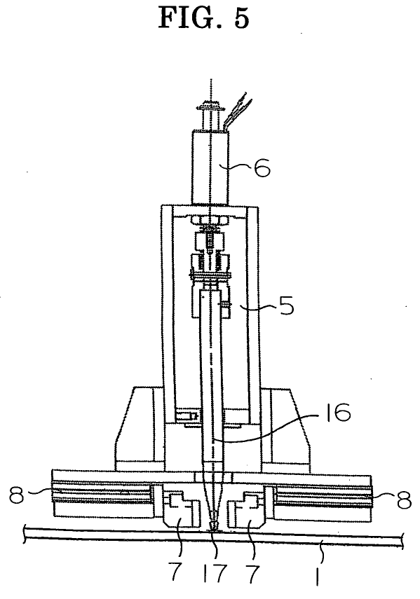

FIG. 5 shows a diagram exhibiting an embodiment of the method of marking a defect in the apparatus of the present invention. By the signal sent from a driving apparatus, air cylinders 8 work, and a shutter 7 of a container tube for an oil-based marking pen is opened. Then, a solenoid 6 for pushing out and pulling back an oil-based marking pen works, and an oil-based marking pen 16 is pushed out of the container tube for an oil-based marking pen. A mark is placed in a product having a sheet form 1 by a tip of the pen 17. When the marking is completed, the oil-based marking pen is pulled back into the container tube for an oil-based marking pen by the working of the solenoid. When the oil-based marking pen has been pulled back into the container tube, the air cylinders 8 works so that the shutter 7 is pushed out, and the container tube for an oil-based marking pen is closed.

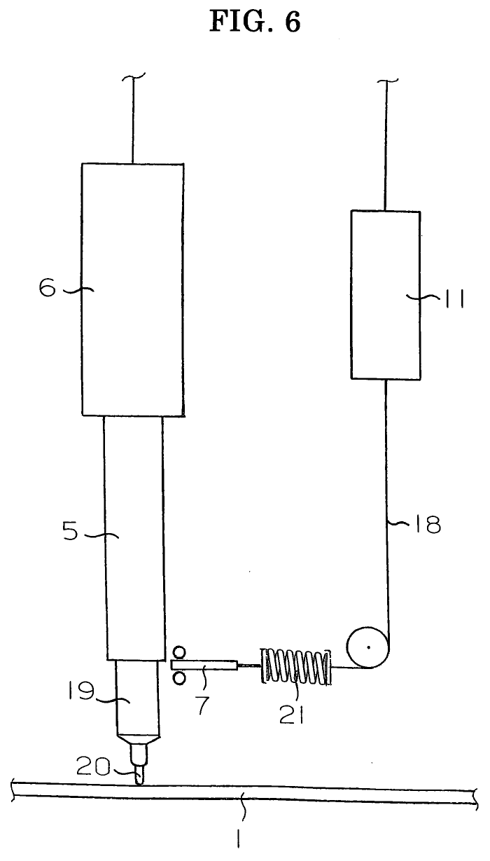

FIG. 6 shows a diagram exhibiting another embodiment of the method of marking a defect in the apparatus of the present invention. By the signal sent from a driving apparatus, a solenoid for opening and closing a shutter 11 works, and a wire 18 is drawn. A shutter for an oil-based marking pen 10 is opened. Then, a solenoid 6 for pushing out and pulling back an oil-based marking pen works, and the oil-based marking pen 19 is pushed out of the container tube for an oil-based marking pen 5. A mark is placed on a transferred product having a sheet form 1 by a tip of the pen 20. When the marking is completed, the oil-based marking pen is pulled back into the container tube for an oil-based marking pen by the working of the solenoid 6. When the oil-based marking pen has been pulled back into the container tube, the solenoid 11 works, and the wire 18 is relaxed. The shutter is pushed out by a spring coil 21, and the container tube for an oil-based marking pen is closed.

In the apparatus of the present invention, an image processing apparatus equipped with a solid image capturing device such as a line sensor and an area sensor can be used as the inspection apparatus. Between these devices, the line sensor is preferable.

The product having a sheet form used for placing a mark at the portion of defect using the apparatus of the present invention is not particularly limited; The apparatus of the present invention can be advantageously applied to films and sheets for optical application used for liquid crystals. Defects in the films and the sheets for optical applications used for liquid crystals which are used for liquid crystal display devices causes unevenness in the images on the display even when the defects are very small. Therefore, the absence of defects is crucial. The films and the sheets for optical applications used for liquid crystals are not used in the form of a long sheet in the final product, but frequently used after being cut into a rectangular shape. Therefore, when a defect is detected, the portion of the defect can be easily removed.

The first embodiment of the apparatus for slitting a film which is an improved structure used in combination with the basic structure of the present invention is an apparatus for slitting a film which transfers a material film, slits the material film by (n−1) slitting blades to form n product films and winds formed n product films, wherein n means for marking are disposed at positions corresponding to positions of the n product films, a defect on the transferred material film is detected by the inspection apparatus, and a mark is placed on a product film having the defect.

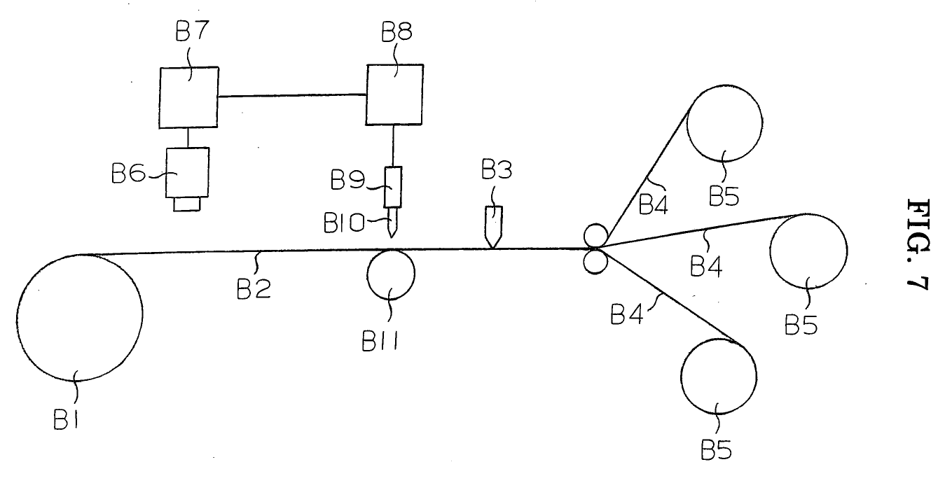

FIG. 7 shows a schematic side view of an embodiment of an apparatus for slitting a film of the present invention. A material film B2 supplied from a roll of a material film B1 is slit by two slitting blades B3 to form three product films 4, which are then wound by a product roll 5. An image of the transferred material film is taken by a CCD camera B6 and processed by an inspection apparatus B7. When a defect is detected in the material film, a signal is sent from the inspection apparatus to a marking apparatus B8. A solenoid corresponding to the product film having the defect works, and an oil-based marking pen B10 is pushed down. A mark is placed at the designated position on the material film transferred on a supporting roll B11. Since the response of the solenoid to the signal is quick, a mark corresponding to the size of the defect in the longitudinal direction can be placed accurately on the product film.

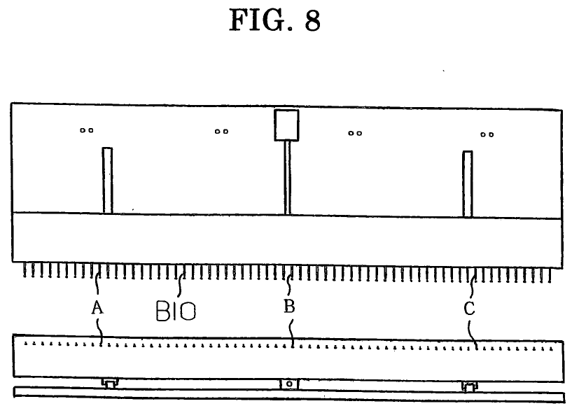

FIG. 8 shows a side view and a plan view of an embodiment of a marking apparatus used for the apparatus of the present invention. In the present embodiment, many oil-based marking pens B10 which are driven by solenoids are arranged over the entire width of the material film. Since the width and the number of the product film formed by the slitting are changed in each lot in many cases in the apparatus for slitting a film, it is preferable that many oil-based marking pens are arranged in the marking apparatus, and oil-based marking pens corresponding to the product films are used for working. In the case shown in FIG. 7 in which the material film is slit into three product films, three marking pens A, B and C can be used for the working.

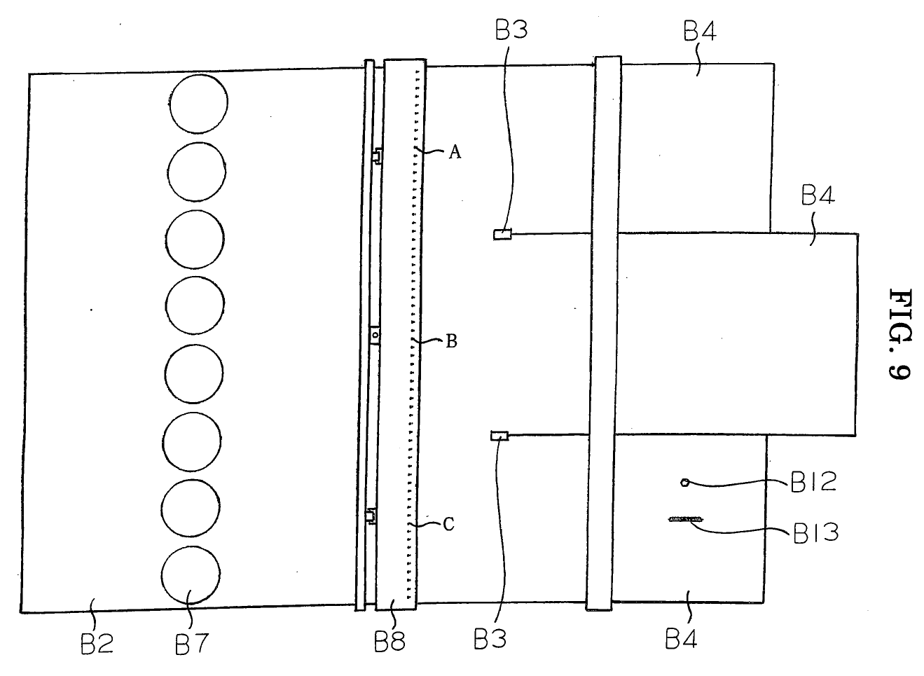

FIG. 9 shows a schematic plan view of an embodiment of the apparatus for slitting a film shown in FIG. 7. A material film B2 supplied from a roll of a material film is slit by two slitting blades B3 to form three product films B4, which are then wound by rolls for product films. Images of the transferred material film are taken by 8 CCD cameras and processed by an inspection apparatus B7. When a defect is detected in the material film, a signal is sent from the inspection apparatus to a marking apparatus B8. A solenoid corresponding to the product film having the defect works, and an oil-based marking pen A, B or C is pushed down. A mark is placed at the designated position on the material film transferred on a supporting roll.

In the embodiment shown in FIG. 9, when a defect B12 is detected on the material film by the inspection apparatus, the oil-based marking pen C is pushed down when the portion of defect in the material film passes the vicinity of the marking apparatus, and a mark B13 is placed at a position such that the portion of defect is contained in the longitudinal direction of the film. The length of the mark is calculated by the image processing apparatus so that the length has a value set in advance. When the defect on the material film is long, a plurality of marks can be placed intermittently. The speed of transfer of the material film is measured using an encoder or the like, and an accurate marking can be conducted in the direction of the transfer of the defect.

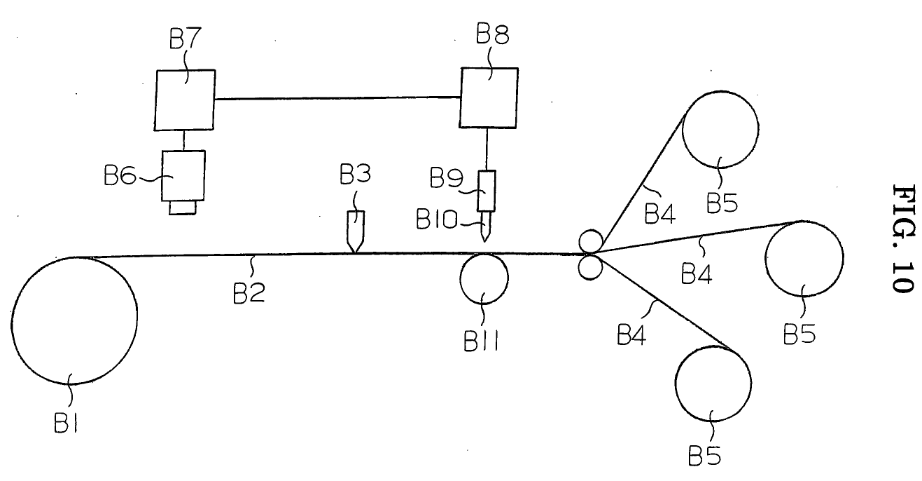

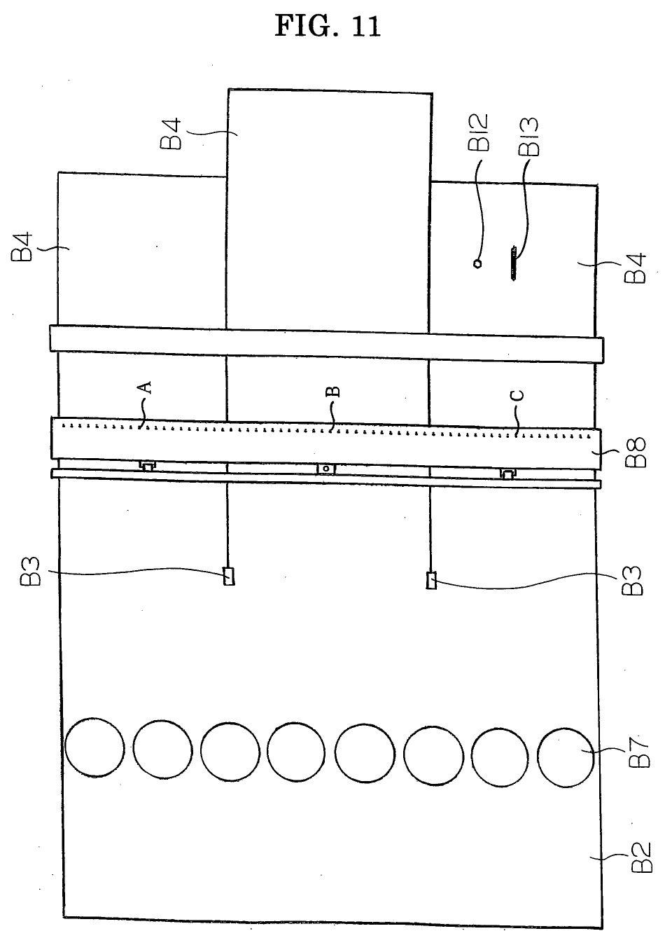

FIG. 10 shows a schematic side view of another embodiment of the apparatus for slitting a film of the present invention. FIG. 11 shows a schematic plan view thereof. In the apparatus for slitting a film of the present embodiment, a slitting blade B3 is disposed at a position upstream of the marking apparatus 8, and a mark is placed on the product film formed by the slitting.

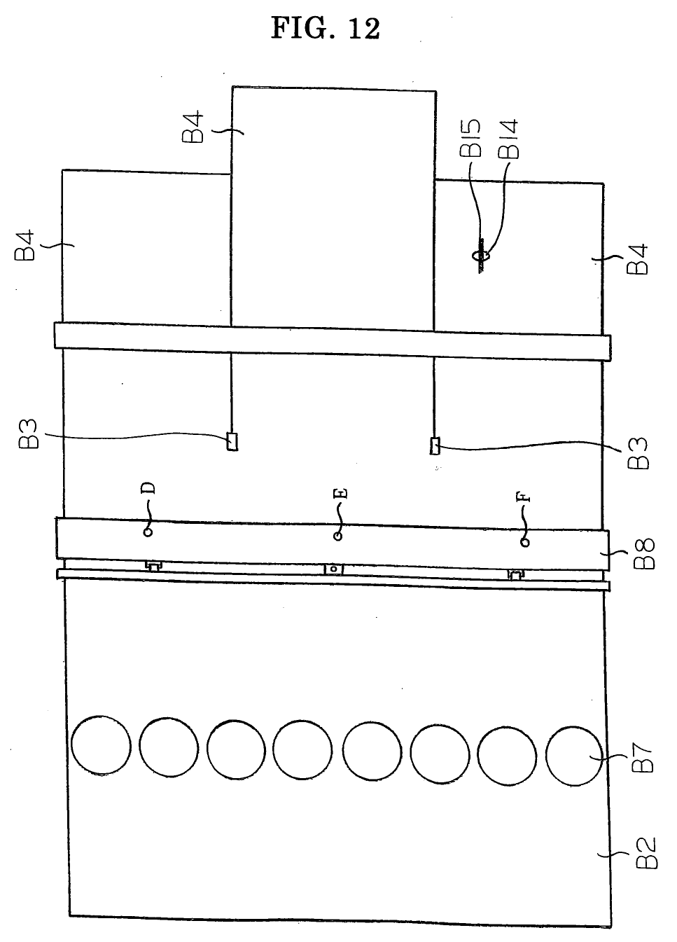

In the apparatus for slitting a film of the present invention, the means for marking can move in the transverse direction of the film, and a mark can be placed on the portion of defect. FIG. 12 shows a schematic plan view of another embodiment of the apparatus for slitting a film of the present invention. A material film 2 supplied from a roll for a material film is slit by two slitting blades B3 to form three product films B4, which are then wound by rolls for product films. Images of the transferred material film are taken by 8 CCD cameras and processed by an inspection apparatus B7. When a defect is detected in the material film, a signal is sent from the inspection apparatus to a marking apparatus B8, and an oil-based marking pen D, E or F corresponding to the product film having the defect moves in the transverse direction to the portion of defect. A solenoid works, and an oil-based marking pen D, E or F is pushed down. A mark is placed at the designated position on the material film transferred on a supporting roll.

In the embodiment shown in FIG. 12, when a defect B14 is detected on the material film by the inspection apparatus, the oil-based marking pen F moves in the transverse direction of the film to the position directly above the portion of defect. When the portion of defect on the material film passes the vicinity of the marking apparatus, the oil-based marking pen F is pushed down, and a mark B15 is placed on the portion of defect of the film. The recognition of the defect in a later step is facilitated by using the apparatus for slitting a film of the present embodiment since the mark is placed directly on the portion of defect. The embodiment can be advantageously applied to works such as visual recognition and repair of the portion of defect.

The second embodiment of the apparatus for slitting a film of the present invention is an apparatus for slitting a film which transfers a material film, slits the material film by (n−1) slitting blades to form n product films and winds formed n product films, wherein at least n+1 means for marking are disposed at positions corresponding to positions of the n product films, a defect on the transferred material film is detected by the inspection apparatus, and a mark is placed on a product film having the defect at the position closest to the defect.

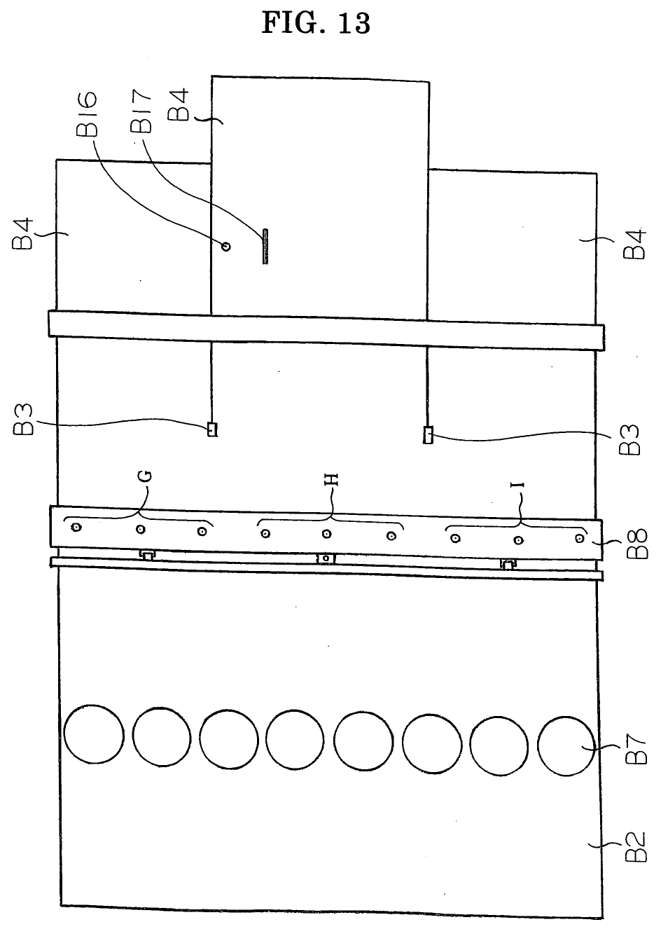

FIG. 13 shows a schematic plan view of another embodiment of the apparatus for slitting a film of the present invention. A material film B2 supplied from a roll for a material film is slit by two slitting blades B3 to form three product films B4, which are then wound by rolls for product films. Images of the transferred material film are taken by 8 CCD cameras and processed by an inspection apparatus B7. A marking apparatus B8 has 9 oil-based marking pens, i.e., 3 oil-based marking pens in each of Group G, Group H and Group I. When a defect is detected in the material film, a signal is sent from the inspection apparatus to a marking apparatus. A marking pen closest to the defect is pushed down, and a mark is placed at the designated position on the material film transferred on a supporting roll.

In the embodiment shown in FIG. 13, when a defect B16 is detected on the material film by the inspection apparatus, the marking pen closest to the defect is a marking pen belonging to Group G. However, the oil-based marking pens belonging to Group G do not belong to product film having the defect. An oil-based marking pen closest to the defect among the oil-based marking pens belonging to Group H corresponding to the product film having the defect works. When the portion of defect in the material film passes the vicinity of the marking apparatus, the oil-based marking pen is pushed down, and a mark B1 is placed at a position containing the portion of defect in the longitudinal direction of the film.

In FIGS. 7 and 9 to 13, the direction of transfer of the film is shown in the horizontal direction to facilitate the understanding. The direction of transfer of the film in the apparatus of the present invention can be set at directions in combination of the horizontal, vertical and desired oblique directions using rolls. By the combination of various directions of transfer, the apparatus for slitting a film can be made compact, and the area for setting the apparatus can be decreased.

In the apparatus of the present invention, the direction of the movement of the means for marking is not particularly limited. For example, the means for marking may be lowered from an upper position to place a mark on the product film and then elevated to the upper position; the means for marking may be moved in the horizontal direction to place a mark on the product film and then pulled back; the means for marking may be elevated from a lower position to place a mark on the product film and then lowered to the lower position; or the direction of moving the means for marking may be set at any angle other than the vertical direction and the horizontal direction. When pushing out and pulling back the means for marking are conducted by the working of a solenoid, it is preferable that the direction of the movement of the means for marking is the horizontal direction since the force of pulling back the means for marking is given by a spring.

In the apparatus of the present invention, the position at which a mark is placed by the oil-based marking pen in the product having a sheet form is not particularly limited. For example, a mark may be placed at a position on the line of contact between the supporting roll transferring the product having a sheet form and the product having a sheet form. Alternatively, a mark may be placed at a position separated from the line of contact between the supporting roll and the product having a sheet form to the upstream side or to the downstream side. When the mark is placed on the line of contact between the supporting roll and the product having a sheet form, wear of the tip of the oil-based marking pen tends to takes place faster. When the mark is place at a position greatly separated from the line of contact between the supporting roll and the product having a sheet form, the stable marking becomes difficult. It is preferable that the position of placing a mark is separated by 1 to 10 mm and more preferably by 3 to 8 mm from the line of contact between the supporting roll and the product having a sheet form.

In the apparatus of the present invention, the position of placing the mark in the transverse direction is not particularly limited. It is preferable that the position is at the central portion in the transverse direction of the film. By placing the mark at the central portion rather than at an end portion in the transverse direction of the film, detection of the defect by visual observation or by the image processing can be facilitated.

When an oil-based marking pen is used, it is preferable that a structure in which the oil-based marking pen is contained in the container tube having a shutter for closing the tip of the pen, the shutter is opened based on a signal sent from the inspection apparatus, the oil-based marking pen is pushed out, a mark is placed on the portion of defect on the material film by the tip of the pen, the oil-based marking pen is pulled back into the container tube when the marking is completed, and then the shutter is closed, is used. By containing the oil-based marking pen into the container tube having the shutter, drying of the tip of the pen can be prevented even when an ink of the quick drying type is used. By using the ink of the quick drying type, the marking can be conducted in a short line having no drying step.

In the apparatus of the present invention, the color of the mark placed by the means for marking is not particularly limited. It is preferable that an easily recognizable color is selected from black, red, blue, green, yellow, white and the like.

In the marking treatment using the apparatus of the present invention, when the product film prepared by the slitting of the material film is an intermediate product film, the defect can be recognized by visual observation or by an image processing in a later step, and the portion of defect can be removed or repaired. When the product film is a final product, the use of the defect portion can be avoided when the completed film is made shorter or formed into cut sheets or when the completed film is used.

In the apparatus of the present invention, an image processing apparatus equipped with a solid image capturing device such as a line sensor and area sensor can be used as the inspection apparatus.

The film slit by the apparatus of the present invention generally means an article having a small thickness relative to the width and the length and includes materials having a thickness of 250 μm or smaller which are films in the proper meaning and materials having a thickness exceeding 250 μm which are called sheets.

The apparatus for marking a defect of the present invention which is the second improved structure used in combination with the basic structure of the present invention is an apparatus for marking a defect which detects a defect in a product having a long sheet form and transferred in a longitudinal direction by an inspection apparatus and places a mark at the portion of the detected defect at a position downstream of the inspection apparatus in the direction of transfer, wherein a marking head having a plurality of marking members arranged in the transverse direction of the product having a long sheet form is disposed, the product having a sheet form is divided into rectangles having a length of an edge in the transverse direction which is the same as the distance between adjacent marking members and a length of an edge in the longitudinal direction having a prescribed value, and, when a defect is detected in a rectangle, a mark of a single line having the same length as the length of the edge of the rectangle in the longitudinal direction is placed in the rectangle in the longitudinal direction.

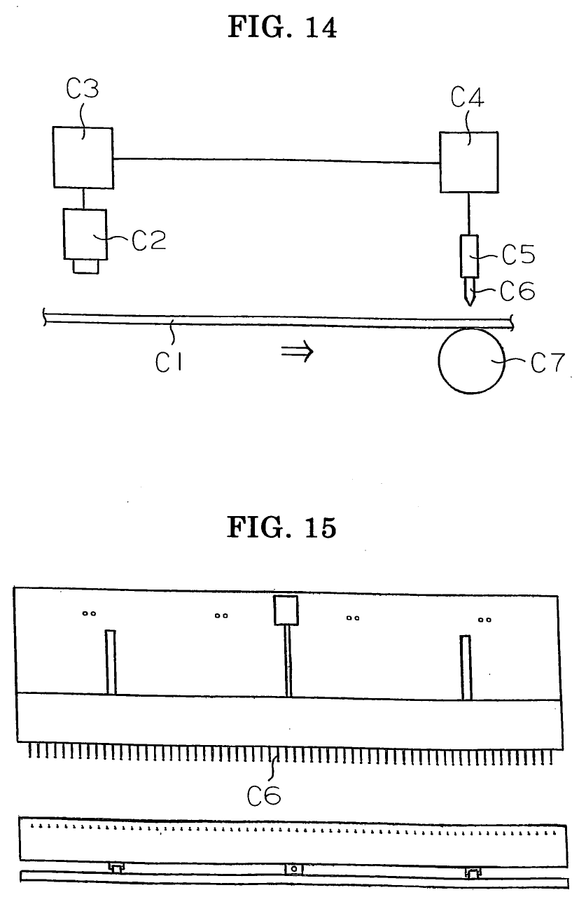

FIG. 14 shows a diagram exhibiting an embodiment of the apparatus for marking a defect of the present invention. A product having a sheet form C1 is transferred in the direction shown by an arrow. An image of the product having a sheet form is taken by a CCD camera C2 and processed by an inspection apparatus C3. When a defect is detected in the product having a sheet form, a signal is sent from the inspection apparatus C3 to a computer C4. The presence or the absence of the defect in each rectangle is decided by the computer without considering the number of the defect. A solenoid C5 works, and a marking member C6 is pushed out. A mark of a single line having the same length as the length of an edge of the rectangle in the longitudinal direction is placed on the rectangle having the defect in the product having a sheet form transferred on a supporting roll C7.

FIG. 15 shows a side view and a plan view exhibiting the arrangement of marking members in another embodiment of the apparatus for marking a defect of the present invention. In the present embodiment, many marking members C6 driven by solenoids are arranged over the entire width of the product having a sheet form at the same distance between each other. When a defect is detected by an inspection apparatus, a signal is sent from the inspection apparatus to a computer. The presence or the absence of the defect in each rectangle is decided by the computer. A marking member is pushed out by a solenoid to the rectangle having the defect in the product having a sheet form, and a mark of a single line having the same length as the length of an edge of the rectangle in the longitudinal direction is placed.

In the apparatus of the present invention, it is preferable that the length of the edge of the rectangle in the longitudinal direction is 0.1 to 10 times and more preferably 0.5 to 2 times as long as the length of the edge of the rectangle in the transverse direction in the product having a sheet form. It is most preferable that the above ratio is 1, meaning that the length of an edge in the longitudinal direction is the same as that in the transverse direction, i.e., the rectangle is a square. When the length of an edge of the rectangle in the longitudinal direction is less than 0.1 time as long as the length of an edge in the transverse direction, there is the possibility that the recognition of a mark is not easy. When the length of an edge of the rectangle in the longitudinal direction is more than 10 time as long as a length of an edge in the transverse direction, the amount of the removed product having a sheet form due to the presence of the defect increases, and there is the possibility that an economic disadvantage arises.

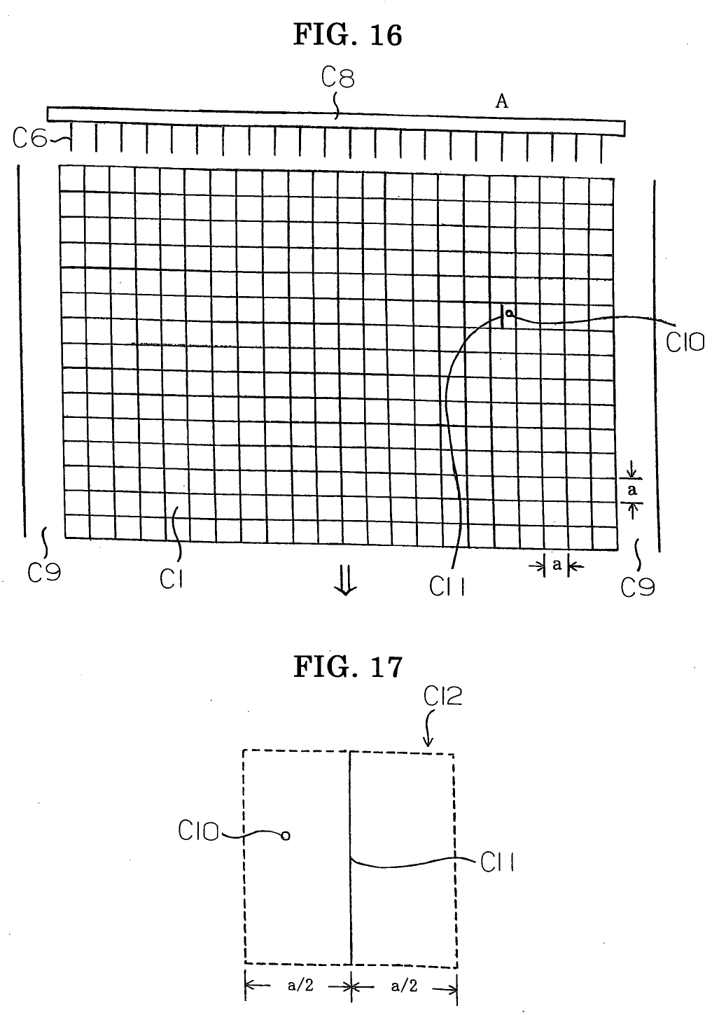

FIG. 16 shows a diagram exhibiting another embodiment of the apparatus for marking a defect of the present invention. A marking head C8 in which a plurality of marking members C6 are arranged is disposed in a manner such that the marking head faces a product C1 having a long sheet form and transferred in the direction shown by an arrow. In the present embodiment, the product having a sheet form is divided into rectangles in which the length of an edge in the transverse direction is the same as the distance between the marking members a and the length of an edge in the longitudinal direction is the same as the length of an edge in the transverse direction a, i.e., squares, except two edge portions C9 of the product having a sheet form. When the edge portions of the product are recovered after being cut off and not used as the final product, the inspection of the edge portions can be omitted. When a defect is detected by an inspection apparatus, a signal is sent from the inspection apparatus to a computer. A marking member A is pushed out when the rectangle having a defect passes the marking head, and a mark of a single line C11 having the same length as the length of an edge of the rectangle in the longitudinal direction is placed in the rectangle in the longitudinal direction.

In the apparatus for marking a defect of the present invention, it is preferable that the marking member is placed at the center of an edge in the transverse direction of each rectangle. FIG. 17 shows a diagram exhibiting an example exhibiting the relation between a defect and a mark in a rectangle. In the present Figure, the four edges of the rectangle are shown by broken lines. When a defect C10 is detected in a rectangle C12, a mark of a single line C11 having the same length as the length of an edge of the rectangle in the longitudinal direction is placed in the rectangle in the longitudinal direction. By placing the marking member at the center of an edge of the rectangle in the transverse direction, the mark is placed at the center of the rectangle in the transverse direction. When the length of an edge of the rectangle in the transverse direction is represented by a, the two edges of the rectangle in the longitudinal direction are present at both side separated from the mark by the distance of a/2. Therefore, even when visual observation of the defect is not easy, the range for searching the defect is clear. Even when the visual observation of the defect is not possible, the portion to be remove from the product having a sheet form can be specified.

FIG. 18 shows a diagram exhibiting another example showing the relation between a defect and a mark in a rectangle. In the present Figure, the four edges of the rectangle are shown by broken lines. When many defects are detected in a rectangle C12, a signal is sent from the inspection apparatus to a computer. The computer decides the presence or the absence of a defect C10 in one rectangle. A mark of a single line C11 having the same length as the length of an edge of the rectangle in the longitudinal direction alone is placed in the rectangle in the longitudinal direction without considering the number of the defect even when many defects are present in the rectangle. Therefore, there is no possibility that the processing capacities of the computer and the marking member becomes insufficient even when many defects are locally concentrated.

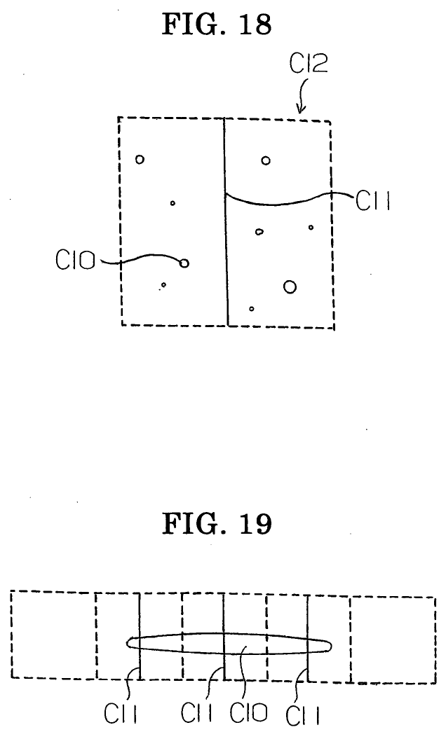

FIG. 19 shows a diagram exhibiting another example showing the relation between a defect in a product having a long sheet form and a mark. In the present Figure, the four edges of the rectangle are shown by broken lines. In the present Figure, a defect C10 which is long in the transverse direction of the product having a long sheet form is present, and one mark C11 having the same length as the length of an edge of the rectangle in the longitudinal direction is placed in the longitudinal direction in each of three rectangles arranged side by side in the transverse direction.

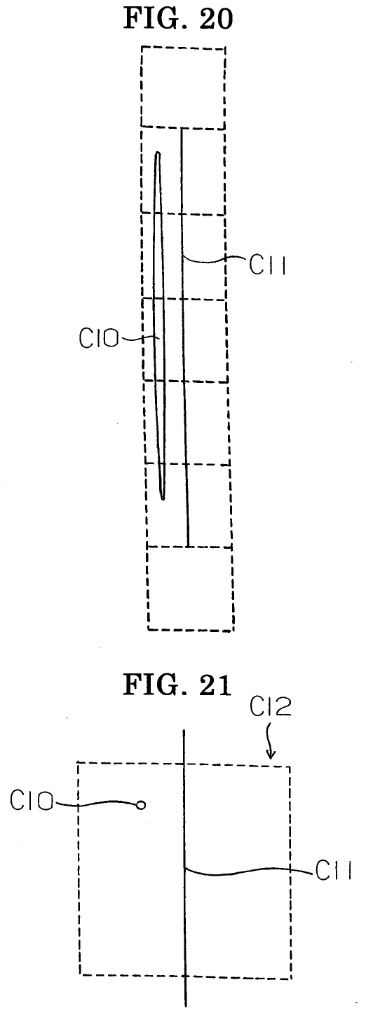

FIG. 20 shows a diagram exhibiting another example showing the relation between a defect and a mark. In the present Figure, the four edges of the rectangle are shown by broken lines. In the present Figure, a defect C10 which is long in the longitudinal direction of the product having a long sheet form is present, and one mark C11 having the same length as the length of an edge of the rectangle in the longitudinal direction is placed in the longitudinal direction in each of five rectangles arranged side by side in the transverse direction. When an apparatus for marking a defect recognizes the entire defect as a single image and places a mark at the portion of defect, the mark cannot be placed for a defect long in the longitudinal direction such as a defect having a length exceeding the distance between the inspection apparatus and the marking head. In contrast, since the apparatus for marking a defect of the present invention decides the presence or the absence of a defect for each rectangle, even when a defect long in the longitudinal direction of the product having a long sheet form is present, the presence or the absence of the defect is decided for each of succeeding rectangles, and marks can be placed from the start point to the end point of the defect long in the longitudinal direction of the product having a long sheet form.

In the apparatus for marking a defect of the present invention, the mark having the same length as the length of an edge in the longitudinal direction placed in the longitudinal direction in a rectangle can be extended forward or backward. FIG. 21 shows a diagram exhibiting another example showing the relation between a defect and a mark. In the present Figure, the four edges of the rectangle are shown by broken lines. When a defect 10 is detected in a rectangle C12, a mark of a single line C11 having a length extended over two edges in the transverse direction of the rectangle is placed in the rectangle in the longitudinal direction. By placing the mark having a length extended over two edges in the transverse direction of the rectangle, the mark having the same length as the length of an edge of the rectangle in the longitudinal direction can be surely placed in the longitudinal direction in the rectangle even when the position of the mark is shifted in some extent.

In the apparatus for marking a defect of the present invention, the mechanism for pushing out the marking member is not particularly limited. It is preferable that the marking member is pushed out by a solenoid and more preferably by a solenoid of the push type. Since the response time of the solenoid of the push type is several tens milliseconds, the marking member can be pushed out in a short time. Therefore, the mark can be accurately and clearly placed on the necessary portion in the divided rectangle following the movement of the product having a long sheet form and transferred at a high speed.

As the marking member used in the present invention, for example, an oil-based marking pen, a pressurized ball pen in which an ink is pushed out by the compressed air contained in the pen and an oil color pencil can be used. Among these marking members, an oil-based marking pen filled with an ink of the quick drying type is preferable. By using the ink of the quick drying type, the marking can be conducted in a short production line having no drying step. When the ink of the quick drying type is used, it is preferable that a shutter for closing the tip of the pen is disposed in the container tube for the marking pen so that drying of the tip of the pen is prevented.

The apparatus for marking a defect of the present invention which is the third improved structure used in combination with the basic structure of the present invention is an apparatus for marking a defect which detects a defect in a product having a long sheet form and transferred in the longitudinal direction by an inspection apparatus and places a mark at the portion of the detected defect at a position downstream of the inspection apparatus in the direction of transfer, wherein a marking member is pushed out and pulled back by working of a solenoid, and a circuit by which a voltage applied to the solenoid and a time of application of the voltage can be adjusted in multiple stages is disposed. In the apparatus for marking a defect, it is preferable that the solenoid is a solenoid of a push type, and a mechanism by which a voltage 1.3 to 10 times as high as a regular voltage is applied to the solenoid in a period of 4 to 50 ms after application of the voltage to the solenoid is started and the voltage is lowered to the regular voltage after the period, is disposed.

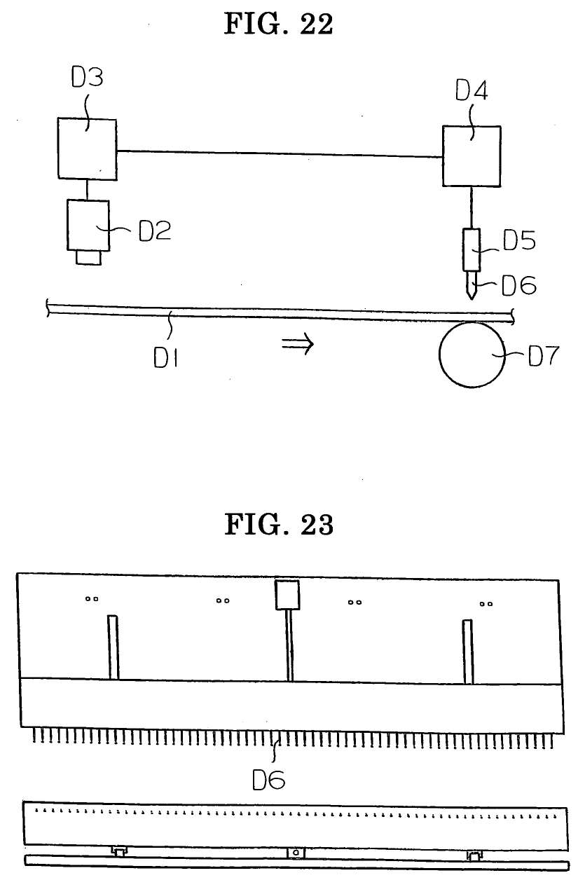

FIG. 22 shows a diagram exhibiting an embodiment of the apparatus for marking a defect of the present invention. A product having a sheet form D1 is transferred in the direction shown by an arrow. An image of the product having a sheet form is taken by a CCD camera D2 and processed by an inspection apparatus D3. When a defect is detected in the product having a sheet form, a signal is sent from the inspection apparatus D3 to a computer D4. A solenoid D5 works, and a marking pen D6 is pushed out. A mark is placed on a designated position in the product having a sheet form transferred on a supporting roll D7.

FIG. 23 shows a side view and a plan view exhibiting the arrangement of a solenoid mechanism in another embodiment of the apparatus for marking a defect of the present invention. In the present embodiment, many marking pens D6 driven by solenoids are arranged over the entire width of the product having a sheet form at the same distance between each other. When a defect is detected by an inspection apparatus, an oil-based marking pen closest to the defect in the transverse direction of the product having a sheet form is pushed out by a solenoid, and a mark is placed. The length of the mark is calculated by the image processing apparatus so that the length has a value set in advance.

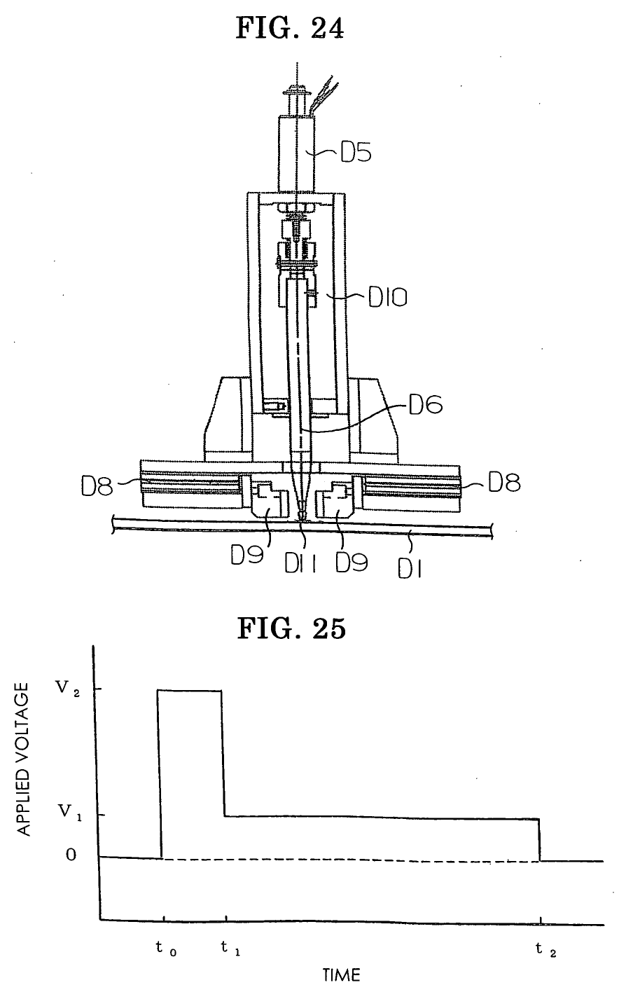

FIG. 24 shows a diagram exhibiting an embodiment of the method of marking a defect by the apparatus of the present invention. Air cylinders D8 work by the signal sent from a driving apparatus, and a shutter D9 of a container tube for a marking pen is opened. Then, a solenoid D5 for pushing out and pulling back an oil-based marking pen works, and an oil-based marking pen D6 is pushed out of the container tube for a marking pen. A mark is placed by the tip of the pen D11 on the product having a sheet form D1 which is transferred. When the marking is completed, the application of voltage to the solenoid is stopped, and the marking pen is pulled back into the container tube for a marking pen. When the marking pen is pulled back, the shutter D9 is pushed out by the working of the air cylinders D8, and the container tube for a marking pen is closed.

FIG. 25 shows a diagram exhibiting an embodiment of the method of applying a voltage by the apparatus for marking a defect of the present invention. When a defect is detected in a product having a sheet form by the inspection apparatus, a voltage V₂ higher than the regular voltage V₁ is applied to a solenoid at a time to. At a time t₁, the applied voltage is lowered to the regular voltage V₁, and the application of the voltage is stopped at a time t₂. By applying a higher voltage to the solenoid at the start of application of the voltage, a shaft is pushed out by a strong force against the elastic force of a recovery spring, and the start point of the mark is placed clearly at the accurate position on the surface of the product having a sheet form by an oil-based marking pen attached to the tip of the shaft. After the sufficient acceleration is provided to the oil-based marking pen, the application of the high voltage V₂ is not necessary. By the application of the regular voltage V₁, the tip of the oil-based marking pen is kept at the condition achieved when the tip has reached the surface of the product having a sheet form, and the marking can be continued. At a time t₂ decided by calculation by the image processing apparatus, the application of the voltage to the solenoid is stopped, and the applied voltage is decreased to zero. The shaft is pulled back into the container tube by the strong force of the spring. The tip of the oil-based marking pen attached to the tip of the shaft quickly leaves the surface of the product having a sheet form, and the end point of the mark is clearly placed at the accurate position.

In the embodiment shown by FIG. 25, the applied voltage is controlled in two stages of V₁ and V₂. The applied voltage may be controlled in multiple stages such as three stages or more by the apparatus of the present invention.

In the apparatus of the present invention, it is preferable that a circuit is designed in a manner such that the possibility that the solenoid is damaged by heating in a continuous operation for a long time is eliminated by lowering the voltage from the voltage V₂ after the start of the application of the voltage to the regular voltage V₁. It is preferable that the voltage V₂ after the start of the application of the voltage to the solenoid is 1.3 to 10 times and preferably 2 to 7 times as high as the regular voltage V₁. When the voltage V₂ after the start of the application of the voltage to the solenoid is smaller than 1.3 times as high as the regular voltage V₁, there is the possibility that the effect of pushing the shaft quickly by a strong force is not sufficiently exhibited. When the voltage V₂ after the start of the application of the voltage to the solenoid is greater than 10 times as high as the regular voltage V₁, the temperature of the solenoid is elevated exceedingly, and there is the possibility that the force of pushing decreases or the coil is damaged by heat.

In the present invention, the period of time when the voltage V₂ higher than the regular voltage V₁ is applied, i.e., (t₁-t₂), is 4 to 50 ms (milliseconds), preferably 5 to 30 ms and more preferably 10 to 20 ms. When the period of time when the voltage V₂ higher than the regular voltage V₁ is applied is shorter than 4 ms, there is the possibility that the acceleration sufficient for quickly pushing the oil-based marking pen by a strong force to the surface of the product having a sheet form is not obtained. When the period of time when the voltage V₂ higher than the regular voltage V₁ exceeds 50 ms, there is the possibility that the temperature of the solenoid increases due to the continued on-off operations, and the coil is damages by heat.

As the marking member used in the present invention, for example, an oil-based marking pen, a pressurized ball pen in which an ink is pushed out by the compressed air contained in the pen and an oil color pencil can be used. Among these marking members, an oil-based marking pen filled with an ink of the quick drying type is preferable. By using the ink of the quick drying type, the marking can be conducted in a short production line having no drying step. When the ink of the quick drying type is used, it is preferable that a shutter for closing the tip of the pen is disposed in the container tube for the marking pen so that drying of the tip of the pen is prevented.

The apparatus for marking a defect of the present invention which is the fourth improved structure used in combination with the basic structure of the present invention is an apparatus for marking a defect which detects a defect in a product having a long sheet form and transferred in the longitudinal direction by an inspection apparatus and places a mark at the portion of the detected defect at a position downstream of the inspection apparatus in the direction of transfer, wherein a mark is placed at an upstream position and another mark is placed at a downstream position of the detected defect, the defect being placed between the marks.

FIG. 26 shows a side view of an embodiment of the apparatus for marking a defect of the present invention. A product having a sheet form E1 is transferred in the direction shown by an arrow. An image of the product having a sheet form is taken by a CCD camera E2 and processed by an inspection apparatus E3. When a defect is detected in the product having a sheet form, a signal is sent from the inspection apparatus E3 to a computer E4. Immediately before the portion of defect reaches by the transfer, a solenoid E5 works, and a marker E6 is pushed down. A mark is placed at a position downstream of the defect in the product having a sheet form transferred on a supporting roll E7. Immediately after the portion of defect passes by the transfer, the solenoid E5 works, and the marker E6 is pushed down again. A mark is placed at a position upstream of the defect in the product having a sheet form transferred on a supporting roll E7.

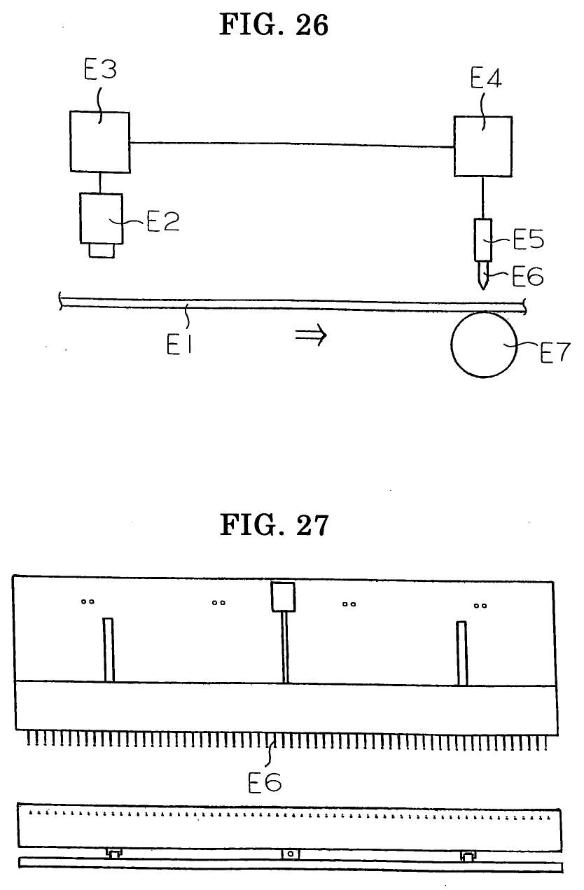

FIG. 27 shows a front view and a plan view exhibiting the arrangement of markers in the embodiment shown in FIG. 26. In the present embodiment, many markers E6 are arranged in the transverse direction of the product having a sheet form over the entire width of the product at the same distance from each other. When a defect is detected by the inspection apparatus, a marker closest to the defect in the transverse direction of the product having a sheet form is pushed down by a solenoid once before and once after the defect passes, and a mark is placed at a downstream position and at a upstream position of the defect. The length of the mark is calculated by the image processing apparatus so that the length has a value set in advance.

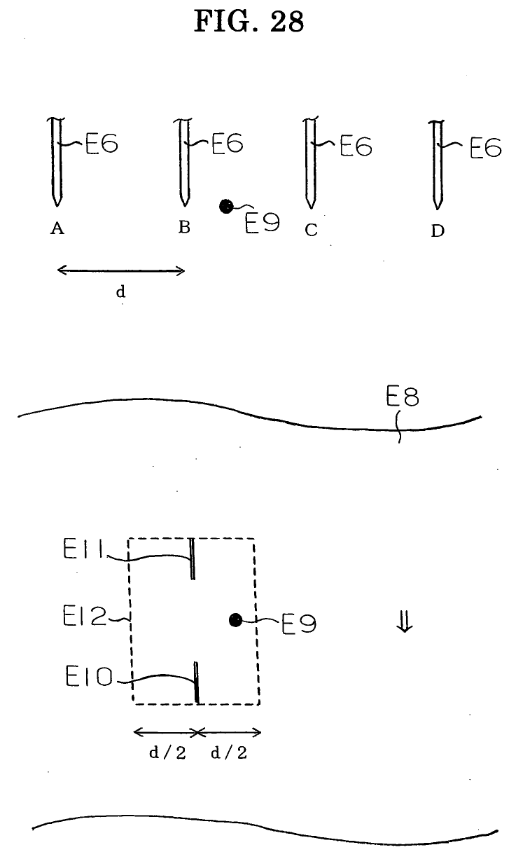

In the apparatus of the present invention, when the defect can be recognized by visual observation using the mark placed at the portion of defect as the index, the portion of defect is removed or repaired in a later step. FIG. 28 shows a diagram exhibiting an embodiment of the mechanism for marking a defect in the apparatus of the present invention. In the present apparatus, many markers A, B, C, D . . . are arranged at the same distance d (mm) between each other. When a defect E9 is detected in a product having a long sheet form E8 by the inspection apparatus, a marker B closest to the defect in the transverse direction is pushed out, and a mark E10 at a position downstream of the defect and a mark E11 at a position upstream of the defect are placed. Since the marker closest to the defect in the transverse direction is pushed out, the distance between the mark and the defect is d/2 (mm) or smaller. When the defect cannot be recognized by visual observation, a rectangular portion E12, which is formed with longitudinal lines having a length which is the distance from the top of the mark at the downstream position to the end of the mark at the upstream position and a width decided by lines each separated from the mark by d/2 (mm), is removed. Since it is sure that the defect is present in the rectangle, the portion of defect can be surely removed by removing the portion having the mark at the center and a width which is the same as the distance between the adjacent markers when the apparatus of the present invention is used.

In the apparatus for marking a defect of the present invention, it is preferable that markers having two different colors each in a plurality of numbers are arranged alternately in the transverse direction of the product having a sheet form, and, when a defect is detected by the inspection apparatus, a marker closest to the defect among markers having one color places a mark at a position downstream of the defect and a marker closest to the defect among markers having the other color places a mark at a position upstream of the defect.

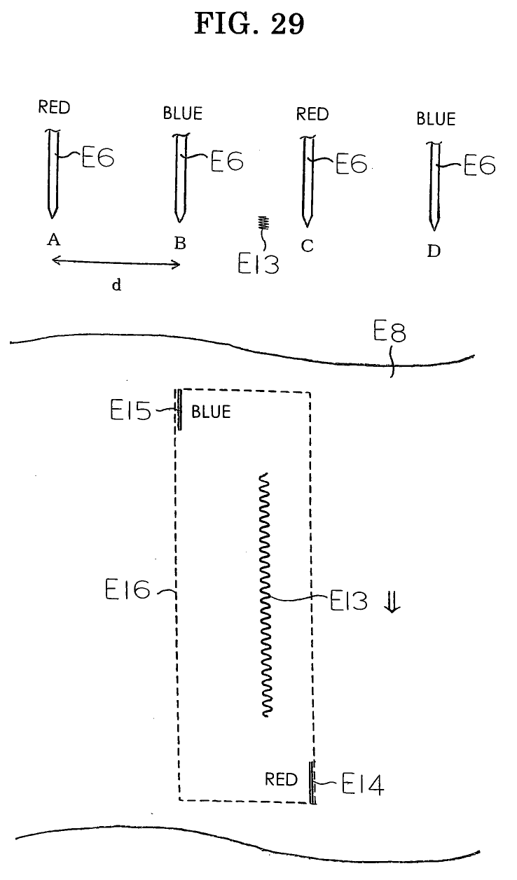

In the apparatus of the present invention, when the defect can be recognized by visual observation or by an image processing, the portion of defect can be removed or repaired in a later step of the working. FIG. 29 shows a diagram exhibiting another embodiment of the mechanism for marking a defect in the apparatus of the present invention. In the present apparatus, many red markers A, C . . . and many blue markers B, D . . . are arranged alternately at the same distance between each other. When a defect E13 is detected in a product having a long sheet form E8 by an inspection apparatus, at a position downstream of the inspection apparatus in the direction of transfer, a red marker C closest to the defect in the transverse direction is pushed down, and a mark E14 at a position downstream of the defect is placed. At a position upstream of the inspection apparatus in the direction of transfer, a blue marker B closest to the defect in the transverse direction is pushed down, and a mark E15 at a position upstream of the defect is placed. Since, a red marker and a blue marker closest to the defect in the transverse direction are successively pushed down when a defect is detected, it is sure that the defect is present in a rectangle E16 containing the red mark at the downstream position and the blue mark at the upstream position. Even when the defect cannot be recognized by visual observation, the portion of defect can be surely removed by removing the rectangular portion E16.

In the apparatus for marking a defect of the present invention, since the marks are placed at two positions, i.e., at the downstream position and at the upstream position, the defect being placed between the two positions, the defect can be indicated by the minimum marking independently of the length of the defect. The product having a long sheet form is worked while being transferred in the longitudinal direction in many cases, and a defect on the surface of a sheet occasionally extends in the longitudinal direction. When the defect is marked at both sides of the portion of defect in the transverse direction of the sheet, marks extending in a long distance are placed, and the ink is consumed rapidly in a method using an oil-based marking pen or in a method of the ink-jet type. In a method of forming a blade mark, a cutting mark or a wear mark, dusts formed in a great amount by the cutting are attached to the product of a sheet form to decrease the quality, and the blade mark, the cutting mark or the wear mark having a long shape tends to cause fracture of the product. By using the apparatus of the present invention, the defect is indicated by the minimum marking independently of the length of the portion of defect, and there is no possibility that problems due to the length of the mark takes place.

In the apparatus of the present invention, it is preferable that many markers are arranged in the transverse direction of the product having a sheet form at the same distance between each other. The distance is preferably 30 mm or smaller and more preferably 15 mm or smaller. The portion to be removed can be made smaller by decreasing the distance between the markers. However, the above distance 30 mm should not be taken rigorously. The distance may be about 300 mm depending on the situation.

In the apparatus of the present invention, when an oil-based marking pen is used as the marker, it is preferable that the oil-based marking pen having a container tube having a shutter for closing the tip of the pen is used, and an oil-based marking pen filled with an ink of the quick drying type is used. By preventing the drying of the tip of the pen and using an ink of the quick drying type, the marking can be conducted in a short production line having no drying step.

In the apparatus of the present invention, it is preferable that a mark is placed by pushing down a marker by a solenoid at the portion of defect of the product having a sheet form. Since the response of the solenoid to a signal is quick, a mark corresponding to the size of the defect in the longitudinal direction can placed accurately on the product having a sheet form.

In the apparatus of the present invention, an image processing apparatus equipped with a solid image capturing device such as a line sensor and area sensor can be used as the inspection apparatus.

The product having a sheet form used for placing a mark at the portion of defect using the apparatus of the present invention is not particularly limited. The apparatus of the present invention can be advantageously applied to films and sheets for optical application used for liquid crystals. Defects in the films and the sheets for optical applications for liquid crystals which are used for liquid crystal display devices causes uneven images in the display even when the defects are very small. Therefore, the absence of defects is crucial. The films and the sheets for optical applications for liquid crystals are not used in the form of a long sheet in the final product, but frequently used after being cut into a rectangular shape. Therefore, when a defect is detected, the portion of the defect can be easily removed.

### EXAMPLES

The present invention will be described more specifically with reference to examples in the following. However, the present invention is not limited to the examples.

### Example 1

A biaxially stretched polyethylene terephthalate film having a width of 1,600 mm and a thickness of 50 μm was inspected. Above the polyethylene terephthalate film, 8 CCD cameras were disposed at a distance of 200 mm between each other. Below the polyethylene terephthalate film, light sources were disposed at positions corresponding to the positions of the CCD cameras. Above the polyethylene terephthalate film, a marking head having 64 pairs of a container tube for an oil-based marking pen worked by a solenoid and a shutter of the container tube worked by an air cylinder which were arranged along the line having the length of the width of 1,600 mm at a distance of 25 mm between each other was disposed at a position downstream of the CCD cameras and the light sources by 2.0 m. Below the polyethylene terephthalate film, a supporting roll was disposed at a position facing the marking head.

As the solvent for the oil-based marking pen, a mixed solvent containing 70% by weight of ethanol and 30% by weight of propylene glycol monomethyl ether was used. The tip of the pen was made of a fiber and had a shape of a column having a thickness of 1.5 mm. The color of the ink was made black by mixing carbon black.

An inspection apparatus for detecting a defect by processing images taken by the CCD cameras and a driving apparatus for opening a shutter of a container tube for an oil-based marking pen closest to the portion of defect and pushing out the oil-based marking pen by a signal sent from the inspection apparatus were connected. The polyethylene terephthalate film was transferred at a speed of 20 m/min, and defects were detected and marked. After 10 hours, defects were detected at 35 positions. The defects were all minute fish eyes. The distance from the mark in the transverse direction was all 12.5 mm or smaller. The tip of the oil-based marking pen was not dried over the period of 10 hours, and the clear marking could be achieved with stability.

### Example 2

A biaxially stretched polyethylene terephthalate film having a width of 1,400 mm and a thickness of 100 μm was inspected. Above the polyethylene terephthalate film, 8 CCD cameras were disposed at a distance of 200 mm between each other. Below the polyethylene terephthalate film, light sources were disposed at positions corresponding to the positions of the CCD cameras. Above the polyethylene terephthalate film, a marking head having 70 pairs of a container tube for an oil-based marking pen worked by a solenoid and a shutter of the container tube worked by an air cylinder which were arranged along the line having the length of the width of 1,400 mm at a distance of 20 mm between each other was disposed at a position downstream of the CCD cameras and the light sources by 2.0 m. Below the polyethylene terephthalate film, a supporting roll was disposed at a position facing the marking head.

As the solvent for the oil-based marking pen, ethanol was used. The tip of the pen was made of a fiber and had a shape of a column having a thickness of 1.0 mm. The color of the ink was made black by mixing carbon black.

An inspection apparatus for detecting a defect by processing images taken by the CCD cameras and a driving apparatus for opening a shutter of a container tube for an oil-based marking pen closest to the portion of defect and pushing out the oil-based marking pen by a signal sent from the inspection apparatus were connected. The polyethylene terephthalate film was transferred at a speed of 20 m/min, and defects were detected and marked. After 10 hours, defects were detected at 41 positions. The defects were all minute fish eyes. The distance from the mark in the transverse direction was all 10 mm or smaller. The tip of the oil-based marking pen was not dried over the period of 10 hours, and the clear marking could be achieved with stability.
An examples of the first improved structure used in combination with the basic structure of the present invention

### Example B1

A polycarbonate material film for a carrier tape for mounting electronic parts having a width of 1,200 mm and a thickness of 0.2 mm was slit to form 60 product films having a width of 20 mm. Above the film, 6 CCD cameras were disposed at a distance of 200 mm between each other. Below the film, light sources were disposed at positions corresponding to the positions of the CCD cameras. Above the film, a marking head having 60 pairs of a container tube for an oil-based marking pen worked by a solenoid and a shutter of the container tube worked by an air cylinder which were arranged along the line having the length of the width of 1,200 mm at a distance of 20 mm between each other was disposed at a position downstream of the CCD cameras and the light sources by 2.0 m. Below the polyethylene terephthalate film, a supporting roll was disposed at a position upstream of the marking apparatus by 5 mm. An inspection apparatus for detecting a defect by processing images taken by the CCD cameras and a driving apparatus for opening a shutter of a container tube for an oil-based marking pen closest to the portion of defect and pushing out the oil-based marking pen by a signal sent from the inspection apparatus were connected. At a position downstream of the marking apparatus by 1.0 m, 59 slitting blades were disposed at a distance of 20 mm between each other. The material film was slit to form 60 product films, which was wound by product rolls.

The material film was transferred at a speed of 20 m/min, and defects were detected and marked. After 10 hours, defects were detected at 28 positions. Among the defects, 19 were minutes holes and 9 were minute cracks. The marks were all placed clearly at the center of the product film having a width of 20 mm at the same positions in the transverse direction as that of the defects.
An examples of the second improved structure used in combination with the basic structure of the present invention

### Example C1

A contaminated film prepared by scattering kaolin to portions of a biaxially stretched polyethylene terephthalate film having a width of 1,600 mm, a thickness of 50 μm and a length of 200 m was inspected. Above the polyethylene terephthalate film, 8 CCD cameras were disposed at a distance of 200 mm between each other. Below the polyethylene terephthalate film, light sources were disposed at positions corresponding to the positions of the CCD cameras. Above the polyethylene terephthalate film, a marking head having 72 oil-based marking pens worked by a solenoid of the push type which were arranged along the line having the length of the width of 1,600 mm at a distance of 22 mm between each other was disposed at a position downstream of the CCD cameras and the light sources by 2.0 m. Below the polyethylene terephthalate film, a supporting roll was disposed at a position facing the marking head.

An image processing apparatus [manufactured by NAGASE & CO., LTD.; SCANTEC] was connected to the CCD cameras. The signal of a defect detected by the image processing apparatus was sent to a personal computer for a general use. The setting was made so that the presence or the absence of the defect was decided in each portion of the polyethylene terephthalate film formed by dividing the film into squares having a length of an edge in the transverse direction of 22 mm and a length of an edge in the longitudinal direction of 22 mm except both edge portions each having a width of 8 mm, and a mark having a length of 22 mm was placed in a square having a defect at the center in the longitudinal direction.

The polyethylene terephthalate film was transferred at a speed of 20 m/min, and defects were detected and marked. In 200 m of the contaminated film, defects were detected at 137 positions. The marking pens worked normally, and marks were placed.
An examples of the third improved structure used in combination with the basic structure of the present invention

### Example D1

A biaxially stretched polyethylene terephthalate film having a width of 1,600 mm and a thickness of 50 μm was inspected. Above the polyethylene terephthalate film, 8 CCD cameras were disposed at a distance of 200 mm between each other. Below the polyethylene terephthalate film, light sources were disposed at positions corresponding to the positions of the CCD cameras. Above the polyethylene terephthalate film, a marking head having 73 pairs of a container tube for an oil-based marking pen worked by a modified solenoid of the push type [manufactured by SHINDENGEN ELECTRIC MANUFACTURING CO., LTD.,; S-0712; the diameter: 19 mm] and a shutter of the container tube worked by an air cylinder which were arranged along the line having the length of the width of 1,600 mm at a distance of 22 mm between each other was disposed at a position downstream of the CCD cameras and the light sources by 2.0 m. Below the polyethylene terephthalate film, a supporting roll was disposed at a position facing the marking head.

In accordance with the general specification for the solenoid of the push type [manufactured by SHINDENGEN ELECTRIC MANUFACTURING CO., LTD.,; S-0712], the regular voltage was 12 V, and the response speed to a stroke was 20 ms when the driving stroke was 5.5 mm under the unloaded condition having nothing attached to the tip of the shaft. The recovery spring of the solenoid of the push type was enhanced so that the weight of an instrument attached to the tip was 30 g and the stroke was 10 mm. A holder for fixing a pen and an oil-based marking pen were attached to the shaft. When a voltage of 48 V was applied in this condition, the response time was 20 ms.

When a defect was detected in the film and the defect reached a prescribed position in the vicinity of the marking head, the container tube of an oil-based marking pen closest to the defect was opened. After the oil-based marking pen was pushed out by applying a voltage of 48 V to the solenoid, the applied voltage was decreased to 12 V, and the oil-based marking pen was kept in the pushed out condition. Setting was made so that, when a mark having a length of 22 mm was placed in the case of a defect having a dot shape or when the entire defect had passed in the case of a defect long in the longitudinal direction of the film, the application of the voltage was stopped, and the oil-based marking pen was pulled back.

The polyethylene terephthalate film was transferred at a speed of 20 m/min, and defects were detected and marked. After 10 hours, defects were detected at 25 positions. The length of the mark was 22 mm for all defects. The start point and the end point of the mark was clearly recognized by visual observation for all marks. The defects were all minute fish eyes. The distance between the mark and the fish eye in the transverse direction was all 11.0 mm or smaller.
An examples of the fourth improved structure used in combination with the basic structure of the present invention

### Example E1

A biaxially stretched polyethylene terephthalate film having a width of 1,600 mm and a thickness of 50 μm was inspected. Above the polyethylene terephthalate film, 8 CCD cameras were disposed at a distance of 200 mm between each other. Below the polyethylene terephthalate film, light sources were disposed at positions corresponding to the positions of the CCD cameras. Above the polyethylene terephthalate film, a marking head having 64 black oil color pencils [manufactured by MITSUBISHI EMPITSU Co., Ltd.; DARMATOGRAPH] worked by a solenoid and arranged along the line having the length of the width of 1,600 mm at a distance of 25 mm between each other was disposed at a position downstream of the CCD cameras and the light sources by 2.0 m. Below the polyethylene terephthalate film, a supporting roll was disposed at a position facing the marking head. An inspection apparatus for detecting a defect by processing images taken by the CCD cameras and a driving apparatus for pushing down a black oil color pencil closest to the portion of defect by a signal sent from the inspection apparatus were connected. The condition was set in a manner such that marks were placed at a portion of 20 to 10 mm in the downstream direction from the transverse line where the front end of the defect was located and at a portion of 10 to 20 mm in the upstream direction from the transverse line where the rear end of the defect was located.

The polyethylene terephthalate film was transferred at a speed of 20 m/min, and defects were detected and marked. After 3 hours, defects were detected at 16 positions. The defects were all minute fish eyes. The defects were located between the mark at the downstream position and the mark at the upstream position in the longitudinal direction. In the transverse direction, the distance between the defect and the straight line connecting the mark at the downstream position and the mark at the upstream position was 12.5 mm or smaller for all defects.

The industrial applicability of the present invention is as follows.

In the basic structure of the apparatus for marking a defect of the present invention, an oil-based marking pen is used as the marking material, the oil-based marking pen is contained in a container tube of an oil-based marking pen closed by a shutter when the oil-based marking pen is not used, and the shutter is opened and the oil-based marking pen is pushed out only when a defect is detected and the marking is conducted. Therefore, the tip of the oil-based marking pen is not dried even when an ink of the quick drying type is used, and the mark placed on a product having a sheet form is dried quickly at an ordinary temperature. No attached facilities such as a drying apparatus are necessary, and the product having a sheet form can be inspected with respect to the defect efficiently and economically. When the detected defect can be recognized by visual observation, the mark can be wiped out with a solvent, and the portion of the product having the mark can be used as the material for the final product.

By the apparatus for slitting a film of the present invention used in combination as an improved structure, slitting a material sheet, detecting a defect on the film and marking the portion of defect on the product film obtained by the slitting can be conducted efficiently in a single step. Since the mark is placed clearly to the portion of defect, the defect can be easily recognized by visual observation or by an image processing. A defect in an intermediate film can be removed or repaired in a later step. When the product film is used as a final product, the film can be used by avoiding the portion of defect.

In the apparatus for marking a defect as the third improved structure used in combination with the basic structure of the present invention, a higher voltage is applied to a solenoid for pushing out a marking member during a short period after the application of the voltage. Therefore, the marking member is pushed out by a strong force at the start of the transfer, and a clear mark is accurately placed on the portion of defect in a product having a sheet form. When the tip of the marking member reaches the surface of the product having a sheet form, the voltage is decreased. Therefore, there is no possibility that the solenoid coil is overheated even when a defect long in the longitudinal direction of the product having a sheet form is present and the marking member is kept pushed out. Since the marking member is quickly pushed out at the start of the transfer, a strong spring can be used as the recovery spring. When the application of the voltage is stopped, the marking member quickly leaves the surface of the product having a sheet form, and the end point of the mark is made clear and accurate. In the apparatus of the present invention, the distance between the marking members can be decreased and the area covered by a single marking member can be decreased by using a small solenoid. The area for removal in the vicinity of the portion of defect can also be decreased.

By using the apparatus for marking a defect as the fourth improved structure used in combination with the basic structure of the present invention, marks can be placed at a downstream position and at a position upstream of the detected defect in a product having a sheet form. Therefore, short marks are sufficient even when the defect is long in the longitudinal direction of the product having a sheet form. In particular, a defect in a product having a sheet form can be recognized easily and surely by using different colors for the mark at the downstream position and for the mark at the position upstream of the defect.

What is claimed is:

1. An apparatus for marking a defect which detects the defect in a product having a long sheet form and transferred in a longitudinal direction by an inspection apparatus and places a mark at a portion of the detected defect at a position downstream of the inspection apparatus in a direction of transfer, wherein an oil-based marking pen is contained in a container tube for an oil-based marking pen having a shutter for closing a tip of the pen, the shutter of the container tube for an oil-based marking pen is opened based on a signal sent from the inspection apparatus, the oil-based marking pen is pushed out of the container tube, a mark is placed at a portion of defect in the product having a long sheet form by the tip of the oil-based marking pen, the oil-based marking pen is pulled back into the container tube after the marking is completed, and the shutter is closed.

2. The apparatus for marking a defect according to claim 1, wherein the shutter is opened and closed by working of an air cylinder, and the oil-based marking pen is pushed out and pulled back by working of a solenoid.

3. The apparatus for marking a defect according to claim 1, wherein opening and closing the shutter and pushing out and pulling back the oil-based marking pen are conducted by using separate solenoids.

4. The apparatus for marking a defect according to claim 1, wherein a solvent of an ink for the oil-based marking pen comprises 80% by weight or more of an aliphatic compound having no halogen atom and having a vapor pressure of 0.5 to 10 kPa at 20° C.

5. The apparatus for marking a defect according to claim 1, wherein the inspection apparatus is a line sensor.

6. The apparatus for marking a defect according to claim 1, wherein many oil-based marking pens are arranged at a same distance between each other in a transverse direction of the product having a long sheet form and, when a defect is detected by the inspection apparatus, an oil-based marking pen closest to the defect in the transverse direction moves and places a mark.

7. The apparatus for marking a defect according to claim 1, which is used as an apparatus for slitting a film which transfers a material film, slits the material film by (n−1) slitting blades to form n product films and winds formed n product films, wherein n means for marking are disposed at positions corresponding to positions of the n product films, a defect on the transferred material film is detected by the inspection apparatus, and a mark is placed on a product film having the defect.

8. The apparatus for marking a defect according to claim 1, which is used as an apparatus for slitting a film which transfers a material film, slits the material film by (n−1) slitting blades to form n product films and winds formed n product films, wherein at least n+1 means for marking are disposed at positions corresponding to positions of the n product films, a defect on the transferred material film is detected by the inspection apparatus, and a mark is placed on a product film having the defect at a position closest to the defect.

9. The apparatus for marking a defect according to claim 1, which detects a defect in a product having a long sheet form and transferred in a longitudinal direction by an inspection apparatus and places a mark at a portion of the detected defect at a position downstream of the inspection apparatus in a direction of transfer, wherein a marking head having a plurality of marking members arranged in a transverse direction of the product having a long sheet form is disposed, the product having a sheet form is divided into rectangles having a length of an edge in the transverse direction which is a same as a distance between adjacent marking members and a length of an edge in the longitudinal direction having a prescribed value, and, when a defect is detected in a rectangle, a mark of a single line having a same length as the length of the edge of the rectangle in the longitudinal direction is placed in the rectangle in the longitudinal direction.

10. The apparatus for marking a defect according to claim 9, wherein a length of the edge of the rectangle in the longitudinal direction is 0.1 to 10 times as long as a length of the edge of the rectangle in the transverse direction in the product having a sheet form.

11. The apparatus for marking a defect according to claim 9, wherein a marking member is placed at a center of an edge of each rectangle in the transverse direction.

12. The apparatus for marking a defect according to claim 1, which detects a defect in a product having a long sheet form and transferred in a longitudinal direction by an inspection apparatus and places a mark at a portion of the detected defect at a position downstream of the inspection apparatus in a direction of transfer, wherein a marking member is pushed out and pulled back by working of a solenoid, and a circuit by which a voltage applied to the solenoid and a time of application of the voltage can be adjusted in multiple stages is disposed.

13. The apparatus for marking a defect according to claim 12, wherein the solenoid is a solenoid of a push type, and a mechanism by which a voltage 1.3 to 10 times as high as a regular voltage is applied to the solenoid in a period of 4 to 50 ms after application of the voltage to the solenoid is started and the voltage is lowered to the regular voltage after the period, is disposed.

14. The apparatus for marking a defect according to claim 1, wherein the apparatus which detects a defect in a product having a long sheet form and transferred in a longitudinal direction by an inspection apparatus and places a mark at a portion of the detected defect at a position downstream of the inspection apparatus in a direction of transfer is used as an apparatus for marking a defect which places a mark at an upstream position and another mark at a downstream position of the detected defect, the defect being between the marks.

15. The apparatus for marking a defect according to claim 14, wherein markers having two different colors each in a plurality of numbers are arranged alternately in a transverse direction of the product having a sheet form, and, when a defect is detected by the inspection apparatus, a marker closest to the defect among markers having one color places a mark at a position downstream of the defect and a marker closest to the defect among markers having an other color places a mark at a position upstream of the defect.
